(19) United States
(12) Patent Application Publication
(10) Pub. No.: US 2014/0108006 A1
(43) Pub. Date: Apr. 17, 2014

(54) SYSTEM AND METHOD FOR ANALYZING AND MAPPING SEMIOTIC RELATIONSHIPS TO ENHANCE CONTENT RECOMMENDATIONS

(71) Applicant: Grail, Inc., Venice, CA (US)

(72) Inventors: Claude Vogel, Key West, FL (US); Ryan Magnussen, Los Angeles, CA (US)

(73) Assignee: Grail, Inc., Venice, CA (US)

(21) Appl. No.: 14/019,482

(22) Filed: Sep. 5, 2013

Related U.S. Application Data
(60) Provisional application No. 61/730,494, filed on Nov. 27, 2012.
(60) Provisional application No. 61/714,654, filed on Oct. 16, 2012.
(60) Provisional application No. 61/698,418, filed on Sep. 7, 2012.

(51) Int. Cl. G06F 17/28; G06Q 30/06

(52) U.S. Cl. CPC G06F 17/28; G06Q 30/0631
USPC 704/9

(57) ABSTRACT

A system and method described in this disclosure seeks to create new ways of defining and mapping relationships between content items in order to create more relevant content recommendations. Semiotic analysis, unlike semantic analysis, looks at how words mean rather than what words mean. Semiotics can define an emotional context for content items, which may be leveraged into content recommendations to users, creating more personalized and meaningful recommendations. The system and method analyze the semiotic context by analyzing the semiotic nature of the content itself through analysis of the writing style or genre of the content item, and the tone in which the content item is written; by analyzing the semiotic nature of the entities extracted from content items; and by analyzing the semiotic nature of the publisher or author who created the content item.

### PRIORITY CLAIMS/CROSS-REFERENCE TO RELATED APPLICATIONS

This application claims the benefit under 35 USC 119(e) and 120 to U.S. Provisional Patent Application Ser. No. 61/698,418, filed Sep. 7, 2012, U.S. Provisional Patent Application Ser. No. 61/714,654, filed Oct. 16, 2012, and U.S. Provisional Patent Application Ser. No. 61/730,494, filed Nov. 27, 2012.

### BACKGROUND

1. Field

This disclosure relates to a system and method for analyzing and mapping semiotic relationships. These relationships may be leveraged into online content recommendations for users.

2. Description of the Related Art

Generally, recommendation and relevance engines recommend relevant articles, documents and other types of content items to users based on semantic analysis and tracked interests, without taking into account other attributes of a given content item.

This method of recommendation imposes a limitation on the level of user personalization, for it provides a one-dimensional, static view of a user's preferences and interests. Without tracking more attributes, recommendations are less discriminatory and more generic, resulting in content that has a broad yet low degree of relevancy.

It is desirable to add layers of nuance to a standard a recommendation engine in order to provide users with results that highly relevant to their individual tastes and preferences. By creating a system and method that analyzes and maps semiotic relationships through identifying writing style and genre (e.g., biographical, laudative, didactic), writing tone and sentiment (e.g., whimsical, sad, light, happy), semiotic personas and semiotic stories, new ways creating relevance are defined and leveraged into recommendation. Thus, it is desirable to provide a system and method that analyzes and maps semiotic relationships for the purpose of enhancing a standard recommendation system, and it is to this end that this disclosure is directed.

### SUMMARY

A system and method of analyzing and mapping semiotic relationships are provided that may be leveraged into content recommendations for users. This method includes collecting documents; gathering metrics from the documents; identifying the semiotic attributes of the documents, such as writing style or genre and writing tone or sentiment, by analyzing the metrics; extracting semiotic stories from the documents; and mapping semiotic personas for entities contained in the documents in order to create more personalized content recommendations for users. The semiotic attributes that are identified in the collected documents include the writing style or genre of the document, the writing tone or sentiment of the document, the semiotic personas of entities extracted from the document, and semiotic stories extracted from the documents.

Writing style or genre is analyzed by gathering metrics from collected documents regarding readability, structure, discourse and content. Writing tone or sentiment is analyzed by extracting semiotic markers through dependency grammar parsing from collected documents in order to form isotones. Dependency grammar parsing is also used to surface semiotic attributes to form semiotic personas for extracted entities. Semiotic stories are created by extracting narrative functions, including actants, and isotopies, in order to form semiotic models to be leveraged and mapped as stories. All of this extracted semiotic information is used to recommend content items to users based on their preferences for certain semiotic attributes.

### BRIEF DESCRIPTION OF THE DRAWINGS

FIG. 1 illustrates a larger content delivery system to be accessed by client devices, according to one embodiment;

FIG. 2 illustrates a larger system that may house the semiotic analysis and mapping system and method along with a content recommendation engine; according to one embodiment;

FIG. 3 is a high-level flow chart illustrating how documents are indexed and analyzed for writing style and sentiment, according to one embodiment;

FIG. 4A illustrates the process of collecting and analyzing a plurality of documents in order to extract metrics from the collected documents to develop stylistic identities, according to one embodiment;

FIG. 4B illustrates the process of collecting and analyzing a plurality of documents in order to extract metrics from the collected documents to develop isotones, according to one embodiment;

FIG. 5A is a flowchart illustrating the process of analyzing individual documents in order to develop one or more stylistic identities, according to one embodiment;

FIG. 5B is a flowchart illustrating the process of analyzing individual documents in order to develop one or more isotones, according to one embodiment;

FIG. 6 is a sample documents to be collected and analyzed for writing style and genre, according to one embodiment;

FIG. 7 is a sample of a document table that is generated from metrics extracted from the collected document, according to one embodiment;

FIG. 8 illustrates an exemplary metrics table that measures the attributes of a corpus of documents, according to one embodiment;

FIG. 9 illustrates a sample metrics table showing correlations between discriminatory attributes derived from a corpus of documents, according to one embodiment;

FIG. 10 is an exemplary graph illustrating correlations between readability metrics and structure metrics, according to one embodiment;

FIG. 11 is an exemplary graph illustrating correlations between readability metrics and discourse metrics, according to one embodiment;

FIG. 12 is an exemplary graph illustrating correlations between readability metrics and content metrics, according to one embodiment;

FIG. 13 is an exemplary table illustrating the percentage of variance regarding eigenvalues during principal component analysis, according to one embodiment;

FIG. 14 is an exemplary graph illustrating the eigenvalues of the first four dimensions resulting from principal component analysis, according to one embodiment;

FIG. 15 illustrates an individual factor map showing how correlations derived from two eigenvalue components are used to map the relationships between one or more writing styles or genres, according to one embodiment;

FIG. 16 illustrates an individual factor map showing how correlations derived from two different eigenvalue components are used to map the relationships between one or more writing styles or genres, according to one embodiment;

FIG. 17 is an illustration of hierarchical clustering of a plurality of sources in order to map relationships between the sources and one or more writing styles or genres, according to one embodiment;

FIG. 18 is a diagram illustrating how tone is created by the layering of author and character voices, according to one embodiment;

FIG. 19 illustrates how dependency grammar is used to parse text, according to one embodiment;

FIG. 20 is an example of the tokenization process performed on the sample collected document, according to one embodiment;

FIG. 21 illustrates the process of creating and comparing entity semiotic personas, according to one embodiment;

FIG. 22 is a diagram illustrating an example of an isotopy semiotic model, according to one embodiment;

FIG. 23 is a sample of a collected document that is parsed using dependency grammar parsing, according to one embodiment;

FIG. 24 is an example of dependency grammar parsing performed on the sample collected document in order to identify isotopies, according to one embodiment;

FIG. 25 is an example of a plurality of isotopies that are extracted during dependency grammar parsing, according to one embodiment;

FIG. 26 illustrates how isotopies are used to form an extracted entity's semiotic profile, according to one embodiment;

FIG. 27 illustrates how entities are mapped and compared based on the features contained in their semiotic personas, according to one embodiment;

FIG. 28 illustrates how entity relationships are mapped, according to one embodiment;

FIG. 29 is a diagram that illustrates how the components of a narrative function are extracted and used to form semiotic stories, according to one embodiment;

FIG. 30 is a diagram illustrating the semiotic square model of communication postures that is used to determine writing tone, according to one embodiment;

FIG. 31 is a diagram of a semiotic dependency model that is used to identify and extract semiotic stories from documents, according to one embodiment;

FIG. 32 is a diagram of an actantial model used to define and extract semiotic stories, according to one embodiment;

FIG. 33 is a diagram of an isotopy ontological map that illustrates how ontologies are created and leveraged into content recommendations, according to one embodiment;

FIG. 34 is an example of a narrative function ontological map that illustrates how ontologies are created and leveraged into content recommendations, according to one embodiment;

FIG. 35 is an example of an actantial ontological map that illustrates how ontologies are created and leveraged into content recommendations, according to one embodiment;

FIG. 36 is an example of a collected document from which semiotic stories may be identified and extracted, according to one embodiment;

FIG. 37 is an example of dependency grammar parsing performed on the sample collected document in order to identify and extract semiotic stories contained in the text of the document, according to one embodiment;

FIG. 38 is an example of a plurality of dependencies that are extracted from the sample collected document, according to one embodiment;

FIG. 39 is an example of how writing style and writing tone are extracted from a collected document in order to extract and define semiotic stories, according to one embodiment;

FIG. 40 is another example of a collected document from which semiotic stories may be identified and extracted, according to one embodiment;

FIG. 41 is an example of dependency grammar parsing performed on the sample collected document in order to identify and extract semiotic stories, according to one embodiment;

FIG. 42 illustrates how words extracted through dependency grammar parsing are mapped in the ontology, according to one embodiment;

FIG. 43A illustrates how the relationships between collected documents are mapped based on their extracted semiotic stories, according to one embodiment; and

FIG. 43B is a larger view of the mapping of collected documents based on their semiotic stories, according to one embodiment.

### DETAILED DESCRIPTION OF ONE OR MORE EMBODIMENTS

Some portions of the detailed descriptions that follow are presented in terms of sequences of operations, which are performed within a computer memory or distributed within a computer system. These descriptions and representations are the means used by those skilled in the data processing arts to most effectively convey the substance of their work to others skilled in the art. A sequence of operations here, and generally, is conceived to be a self-consistent sequence of steps leading to a desired result. The steps are those requiring physical manipulations of physical quantities. Usually, though not necessarily, these quantities take the form of electronic or magnetic signals capable of being stored, transferred, combined, compared or otherwise manipulated.

It should be borne in mind, however, that all of these and like terms are to be associated with the appropriate physical quantities and are merely convenient labels applied to these quantities. Unless specifically stated otherwise, it is appreciated that throughout the description, discussion utilizing the terms such as “processing”, “computing”, “calculating”, “determining” or “displaying” and the like, refer to the actions and processes of a computer or a network of computer systems or similar electronic devices that manipulate and transform data represented as physical (electronic) quantities within the computer network's registers and memories into other data similarly represented as physical quantities within the electronic devices' memory or registers or other such information storage, transmission or display devices.

The embodiments disclosed also relate to an apparatus for performing the operations herein. This apparatus may be specially constructed for the required purposes, or it may comprise a general-purpose processor selectively activated or reconfigured by a computer program stored in the electronic device. Such a computer program may be stored in a computer readable storage medium, such as, but not limited to, any type of disk, including floppy disks, optical disks, CD-ROMs, magnetic-optical disks, read-only memories (ROMs), random access memories (RAMs), EPROMs, EEPROMs, Flash memory, magnetic or optical cards, or any type of media suitable for storing electronic instructions, and each coupled to a computer system bus.

The sequence of steps described herein is not inherently related to any particular electronic device or apparatus. Various general-purpose systems may be used with programs in accordance with the teachings in this disclosure, or it may prove convenient to construct a more specialized apparatus to perform the required method steps. The required structure for a variety of these systems will appear from the description below. It will be appreciated that a variety of programming languages may be used to implement the teachings of the embodiments as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entities for the purpose of original disclosure, as well as for the purpose of restricting the claimed subject matter. Furthermore, it is expressly noted that the dimensions and the shapes of the components shown in the figures are designed to help understand how the present teachings are practiced, but not intended to limit the dimensions and shapes shown in the examples.

For the purposes of this disclosure, the terms “content” and “content item” are used broadly to encompass any product type or category of creative work including any work that is in electronic form that is renderable, experienceable, retrievable, computer-readable filed and/or stored in memory, either singly or collectively. Individual items of content include songs, tracks, pictures, images, movies, articles, books, ratings, reviews, descriptive tags, or computer readable files. However, the use of any one terms is not to be considered limiting as the concepts, features, and functions described in this disclosure are generally intended to apply to any work that may be experienced by a user, whether aurally, visually, or otherwise, in any manner known or to become known. Furthermore, the terms “content” and “content item” may include audio, video and products embodying the same. As mentioned above, there are many digital forms for audio, video, digital or analog media data and content, embodiments of the systems and methods described in this disclosure may be equally adapted to any format or standard now known or to become known.

In one embodiment, the system and method may be implemented in one or more functional modules. As used throughout the description, the term module refers to logic embodied in hardware or firmware, or to a collection of software instructions, possibly having entry and exit points, written in a programming language, such as Java. A software module may be compiled and linked into an executable program, or installed as a dynamic link library, or may be written in an interpretive language such as Python. It will be appreciated that software modules may be callable from other software modules, and/or may be invoked in response to detected events or interrupts. Software instructions may be imbedded in firmware, such as EPROM. It will be further appreciated that hardware modules may be comprised of connected logic units, such as gates and flip-flops, and/or may be comprised of programmable units, such as programmable gate arrays. The modules described in this disclosure are preferably implemented as software modules, but could be implemented in hardware or firmware.

In one embodiment, each module is provided as modular code, where the code typically interacts through a set of standardized function calls. In one embodiment, the code is written in a suitable software language such as Java, but the code can be written in any low-level or high-level language. In one embodiment, the code modules are implemented in Java and distributed on a server, such as, for example, Microsoft™ IIS or Linux™ Apache. Alternatively, the code modules can be compiled with their own front end on a kiosk, or can be compiled on a cluster of server machines serving interactive television content through a cable, packet, telephone, satellite or other telecommunications network. Those skilled in the art will recognize that any number of implementations, including code implementations directly to hardware, are also possible.

For example, the system may include a database. As is well known, the database categories above can be combined, further divided or cross-related, and any combination of databases and the like can be provided from within the a server. In one embodiment, any portion of the databases can be provided externally from a website, either locally on the server, or remotely over a network. The external data from an external database can be provided in any standardization form which the server can understand. For example, an external database at a provider can provide end-user data in response to requests from the server in a standard format, such as, for example, name, user identification, and computer identification number, and the like, and the end-user data blocks are transformed by a database management module into a function call format which the code modules can understand. The database management module may be a standard SQL server, where dynamic requests from the server build forms from the various databases used by the website as well as store and retrieve related data on the various databases.

As can be appreciated, the databases may be used to store, arrange and retrieve data. The databases may be storage devices such as machine-readable mediums, which may be any mechanism that provides (i.e., stores and/or transmits) information in a form readable by a processor. For example, the machine-readable medium may be a read only memory (ROM), a random access memory (RAM), a cache, a hard disk drive, a floppy disk drive, a magnetic disk storage media, an optical storage media, a flash memory device or any other device capable of storing information. Additionally, a machine-readable medium may also comprise computer storage media and communication media. A machine-readable medium includes volatile and non-volatile, removable and non-removable media implemented in any method or technology for storage of information, such as computer-readable instructions, data structures, program modules or other data. Machine-readable medium also includes, but is not limited to RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by a computer.

According to a feature of the present disclosure, a machine-readable medium is disclosed. The machine-readable medium provides instruction which, when read by a processor, causes the machine to perform operations described or illustrated in this disclosure. The machine-readable medium may be any mechanism that provides (i.e., stores and/or transmits) information in a form readable by a processor. For example, the machine-readable medium may be a read only memory (ROM), a random access memory (RAM), a cache, a hard disk drive, a floppy disk drive, a magnetic disk storage media, an optical storage media, a flash memory device or any other device capable of storing information.

The system and method described in this disclosure seeks to create new ways of defining and mapping relationships between content items in order to create more relevant content recommendations. Semiotic analysis, unlike semantic analysis, looks at how words mean rather than what words mean. Semiotics can define an emotional context for content items, which may be leveraged into content recommendations to users, creating more personalized and meaningful recommendations. The system and method described in this disclosure analysis the semiotic context by analyzing the semiotic nature of the content itself through analysis of the writing style or genre of the content item, and the tone in which the content item is written; by analyzing the semiotic nature of the entities extracted from content items; and by analyzing the semiotic nature of the publisher or author who created the content item.

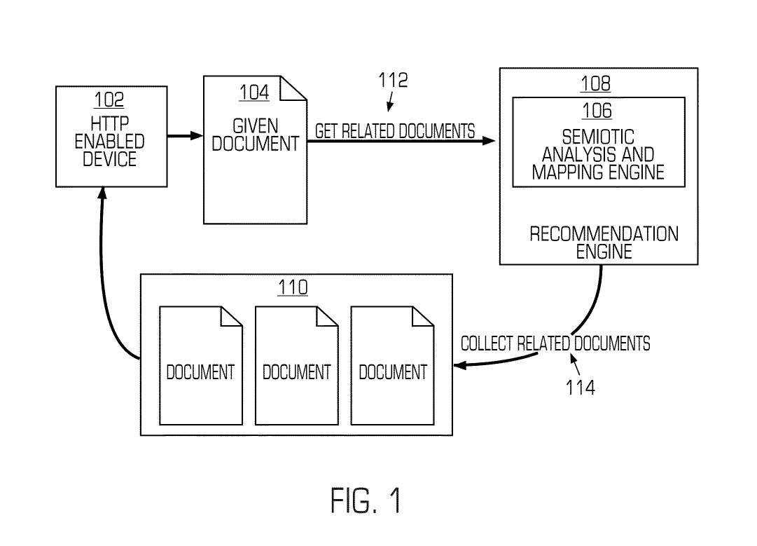

A larger content recommendation system to be accessed by client devices is shown in FIG. 1. This larger content recommendation system may contain a content recommendation engine 108 that surfaces relevant content items to a user on one or more HTTP enabled devices 102. The recommendation engine 108 may be coupled to the one or more HTTP enabled devices 102 over a link (not shown in FIG. 1) in which the link may be a wired link, such as the Ethernet or the Internet, or a wireless link, such as a wireless data network. The one or more HTTP-enabled devices 102 sends a request for documents 112 related to the given document 104 to one or more servers, which may be implemented using one or more known server computers or one or more cloud computing resources or the like, housing a recommendation engine 108, of which a semiotic analysis and mapping engine 106 is a part. This request may also take the form of tracked user preferences for certain writing styles or genres or certain writing tones or sentiments. As a result of the analysis, the recommendation engine 108 returns the request by posting on or more related documents 114 that are accessed 110 by the HTTP enabled device that made the original request. Each HTTP enabled device 102 may be a processor-based device with memory, persistent storage, a display and wired or wireless communication capabilities to connect to and interface with the content recommendation system. For example, each HTTP enabled device may be a smartphone device, personal computer, a tablet computer, a laptop computer a terminal and the like.

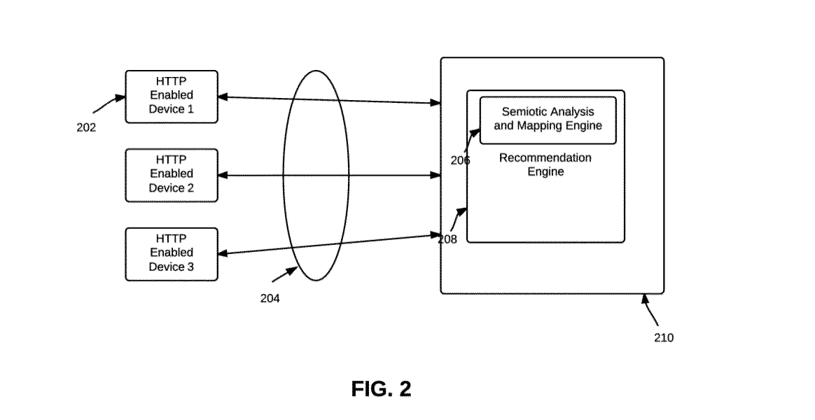

FIG. 2 illustrates an example of a larger system that implements the semiotic analysis system and method described in this disclosure. The system may include one or more HTTP enabled devices 202, wherein each HTTP enabled device may be a processing unit-based device that can communicate using HTTP protocol, such as an Apple iPhone, Android device, personal computer, tablet computer and the like. The system also has a link 204 (that may be a wireless or wired link) that allows one or more HTTP enabled devices to communicate with a backend system 210. The backend system may further comprise a semiotic analysis and mapping engine 206 that can connect to a backend store (that stores the data and information on which the system operates) and operates as described in FIG. 1. In one embodiment, the semiotic analysis engine 206, the store 210 and the recommendation engine 208 may each be implemented as a plurality of lines of computer code that are each executed by one or more processors of the backend system computers (such as one or more server computers or one or more cloud computing resources) to implement the functions and operations described.

The first part of the semiotic analysis system and method described in this disclosure deals with recommending content items to users based on the writing style or tone in which the content item is written. User behavior is tracked in order to learn what writing styles or tones a user prefers, and content is recommended to a user that contains writing styles or tones similar to what the user prefers. This allows for greater personalization in content recommendations.

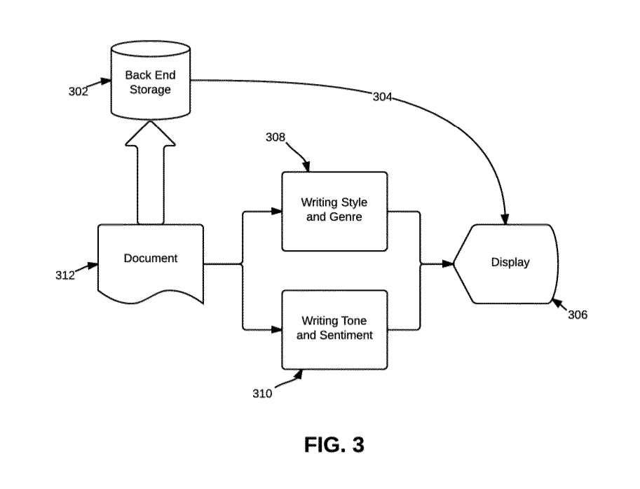

An indexing process that is leveraged to deliver relevant documents that embody the same or similar writing style and genre (collective referred to throughout the disclosure as “writing style”) and the same or similar writing tone and sentiment (collectively referred to throughout the disclosure as “writing tone”) is shown in FIG. 3. These documents may be recommended to a user, based on the user's tracked preferences for certain writing styles or tones, in a content recommendation system similar to the system described in FIG. 1. One or more documents 312 are harvested in known manners and stored in a backend storage device 302, such as hardware or software database, and scraped using a well-known crawler, to extract text from the document. The extracted text is analyzed for writing style and genre 308 and writing tone and sentiment 310 (e.g., happiness, sadness, hostility, etc.). After analysis, the document is displayed to the user of a front-end interface 306.

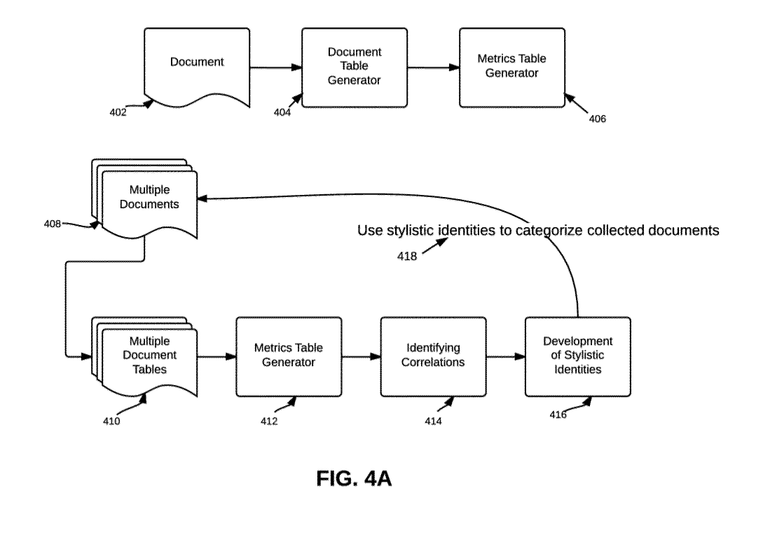

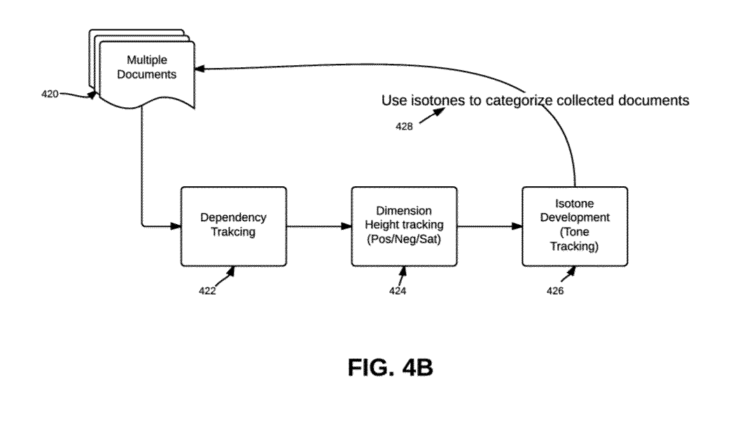

Writing style and writing tone are analyzed by gathering metrics, aggregating the metrics into tables, identifying correlations between certain metrics, and using those correlations to define different writing styles or tones. FIG. 4A illustrates a method of analyzing the writing style of a document by converting one or more documents into a document table, which thereafter is condensed into one or more lines of data and entered into a metrics table. A document table 404 is created by tracking a plurality of attributes from one or more documents 402, with each line of information in the table devoted to each collected document. Then, the document tables are compressed into one or more lines of data and entered into a metrics table that is generated by a metrics table generator 406. The metrics table will be used to define the parameters (hereinafter “correlations”) of one or more writing styles and genres, which will be used to categorize and index collected documents.

This same process used for a single document is repeated with a plurality of documents and a plurality of metrics tables in order to define a plurality of stylistic identities. Document tables 410 are created from multiple documents 408, and contain a plurality of attributes derived from extracted and analyzed text. After documents tables are created for each collected document, as described in the paragraph above, each table is condensed into one row of data and entered into a generated metrics table 412. Correlations, which are attributes collected from various documents that are discriminatory in nature and serve as markers of various styles or genres, are identified 414 between the data contained in the metrics table. These correlations serve as markers of stylistic identities 416 and may be leveraged to categorize and index collected documents according to their similar stylistic identities 418.

A process based on extracting information (not unlike the process of gathering metrics in order to define writing styles) may also be used to develop writing tone profiles (known as “isotones” throughout the rest of the disclosure). FIG. 4B illustrates a method for analyzing a plurality of documents 422 in order to recommend the documents to users based on their isotone profile. Narrative dependencies are extracted from the text of documents and tracked 422 and used to identify the dimension height 424 of the extracted text. Dimension height measures the positive, negative or satirical orientation of the extracted text. The dimension height and extracted narrative dependencies are used to define different semiotic isotopes, known throughout the rest of this disclosure as isotones 426. These defined isotones are used to index and categorize the documents, so documents with similar isotones are indexed together 428. By indexing content items by their isotone category, the system and method in this disclosure may leverage the indexing into content recommendations made to users based on the tone of the content item.

In one embodiment, the system and method described herein analyze semiotic patterns of communication in a plurality of documents to determine a particular document's tone and sentiment. Collected documents are matched against an index comprised of semiotic patterns of communication called ‘isotones’. The term of art ‘isotones’ is based on the semiotic concept of ‘isotopy’, which is a longitudinal study of topic markers. An isotopy is created when similar patterns are repeated across the same collection of linguistic materials (e.g., units of communication: text, utterances, etc.). A collection may consist of one single document or a set of documents grouped together for some reason: time, author, source, general opinion, etc. Patterns may include semantic categories, rhetorical figures of discourse, semiotic expressions of sentiments, style and tone used to convey the message, etc. Similarities are found when a category or figure pertains to the same classes of categories and figures that another category or figure belongs to.

Isotopies rarely occur alone—they are generally correlated to create more complex figures, by opposition or accumulation, by synchronization or alternation, or any other rhetorical figure (gradation, cycles, etc.). Correlations between isotopes/isotones may be identified by measuring the distance between isotopes and/or isotones within the same dependency graphs. Isotopes and/or isotones are co-dependents when they have a common ancestor within the same dependency graph. An isotopy/isotone is isotonic if the same tone is recurrent across the isotopy. The tone is used to create a posture effect, and is likely to be found co-occurrent with other semantic and semiotic isotopies/isotones. Hence, the isotonic isotopy/isotone will occur as a specific posture enhancement figure, correlated to semantic and semiotic isotopies/isotones.

Therefore, the concept of ‘isotones’ refers to a consistent tone of voice that is used throughout text. When the semiotic or semantic attributes of a document match particular semiotic or semantic attributes of an indexed isotone, the document is indexed accordingly. The document is then delivered to a user based on a user's tracked preferences for certain isotones.

The writing tone of a document is the result of mixed patterns, consisting of voice, genre, style, emotions, etc. Tone is linked closely to mood, but tends to be more associated with voice. In linguistics, tone is part of prosody—the forms of rhythm and intonation associated with speech. Once speech is considered as text, the tone becomes more subjective, i.e., tone contributes to express the subject's posture in the text, whether the subject is a character or the author. In that context, tone appears as a specific inflection in the choice of vocabulary and patterns of style. The basic features of prosody still apply: loudness, pitch, rhythm, etc. However, prosody is not well equipped to deal with a macro-analysis of tone characterizations throughout a text or a character's voice. From that perspective, tone is a pattern of communication, which is better understood in its macro-relationships with other semiotic patterns: voice, genre, style and emotions.

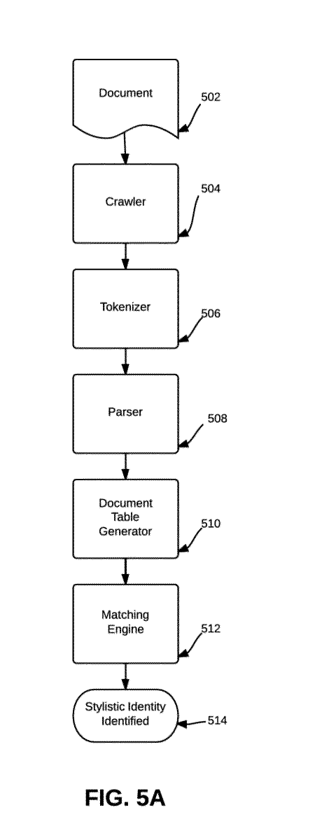

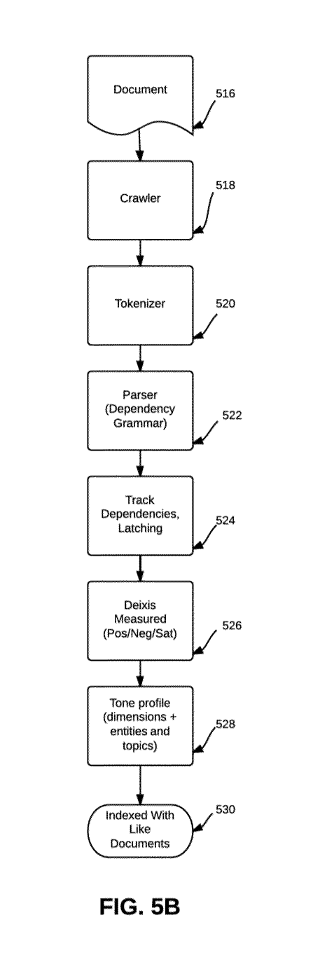

FIG. 5A illustrates in greater detail a process of collecting one or more documents and analyzing text extracted from the documents to determine the writing stylistic identity of a particular document. A document is collected 502 and the text is scraped using a well-known crawler 504. The extracted text then goes through a tokenization process 506, during which the tokens extracted from the document go through stemming, parts-of-speech analysis, and identification of idioms, locutions, and phrasal verbs. The tokens may be parsed 508, wherein named entities and noun phrases are extracted. The tokens entered into a document table generator to create a document table 510 in order to track a plurality of correlations (e.g., how many characters comprise each token, how many words per clause, words per sentence, etc.). A matching engine 512 compares the correlations contained in the document table against the correlations that define one or more stylistic identities. The matching engine also includes a latching mechanism to latch extracted noun phrases and named entities into taxonomies. If the correlations from the document table match correlations that define a particular stylistic identity 514, the document is indexed accordingly.

A similar process is used for analyzing the isotone profile of a plurality of documents, shown in FIG. 5B. A document is collected 516 and the text is scraped using a crawler 518 to generate extracted text. The extracted text goes through a tokenization process 520, during which the tokens are put through the processes of stemming, parts-of-speech analysis, and identification idioms, locutions and phrasal verbs. After tokenization, the tokens are parsed 522 at the phrase, clause and sentence level for dependency grammar, where dependencies are identified. These dependencies are tracked, matched and latched 524 into a taxonomy of dimensions. The height of the dimensions is measured and a positive, negative or satirical tone determination is made 526 for each sentence contained in the extracted text. The number of sentences embodying each tone is tracked, and, coupled with extracted entities and topics from the text, is used to define an isotone profile for the document 528. Documents with like isotone profiles are indexed together 530 in order to be leveraged into content recommendations.

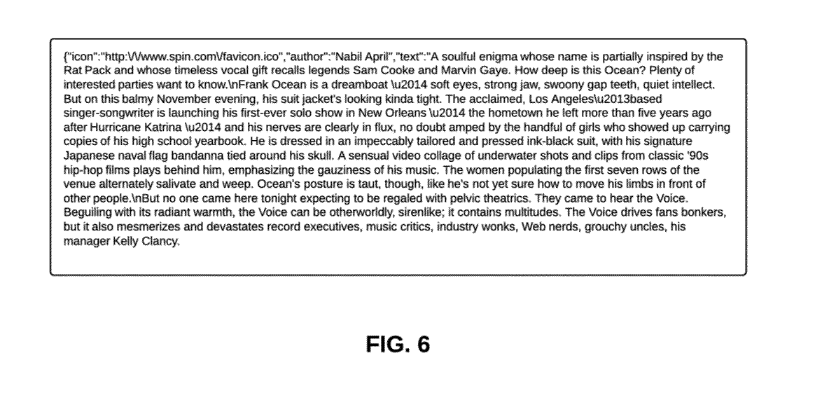

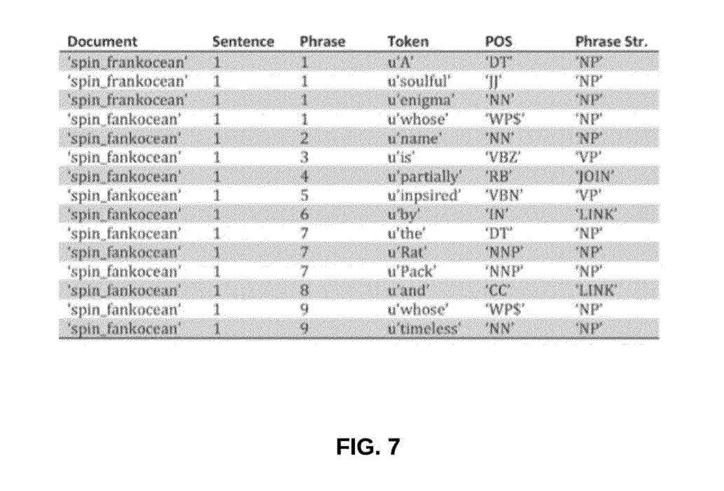

To demonstrate how writing style is defined for a collected document, a sample collected document is illustrated in FIG. 6 This document is an excerpt from a music article on the artist Frank Ocean. Here, the first sentence of the document serves as the basis for the example of the analysis process. A sample section of a document table analyzing the first sentence of the article is shown in FIG. 7. Each row in the table comprises a single token extracted from the text. The columns contain a plurality of attributes of the document, including, but not limited to, the particular sentence the token is contained in (e.g., “1”, “2”, “3”, etc.), the particular phrase the token is contained in (e.g., “1”, “2”, “3”, etc.), the part-of-speech categorization (e.g., “DT” meaning “determiner”, “JJ” meaning “adjective”, “NN” meaning “noun”, etc.), and a phrase structure categorization (e.g., “NP” meaning “noun phrase”, etc.).

In this particular embodiment, extracted text from documents is analyzed for writing style and genre by tracking metrics regarding the different levels of structural complexity present in a document. The levels of structural complexity range from the simplest level of structure, “character”, and to the most complex level of structure, “article”. A character may refer to an alphabetical letter, number or symbol; a word refers to individual words contained in the document, no matter the length or the word; a phrase refers to a collection of words, which may comprised of nouns or verbs, but does not include a subject doing the verb; a clause also refers to a collection of words, however, a clause contains a subject actively doing the verb included in the collection; sentence refers to a collection of words containing a noun, subject and verb; paragraph refers to a group of sentences, generally comprising two or more sentences; and article refers to the entire document. These levels of structural complexity are applied as metrics to the tokens in order to identify correlations.

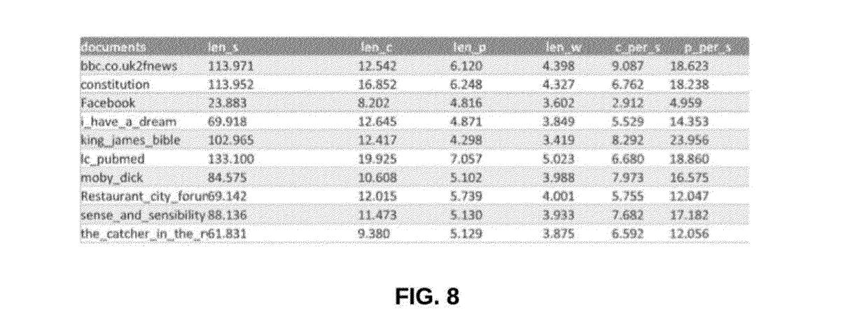

FIG. 8 illustrates an example of the metrics taken at the different levels of structural complexity contained within a corpus of documents. Each row consists of a different document in the corpus, while each column measures a different level of structural complexity: sentence length (“len_s”), clause length (“len_c”), phrase length (“len_p”), word length (“len_w”), clauses per sentence (“c_per_s”), and phrases per sentence (“p_per_s”). However, metrics to be analyzed in a corpus of documents are not limited to the above enumerated metrics, and may include other structural complexity metrics such as occurrence per sentence, phrases per clause, occurrences per clause, max sentence length, max clause length, etc.

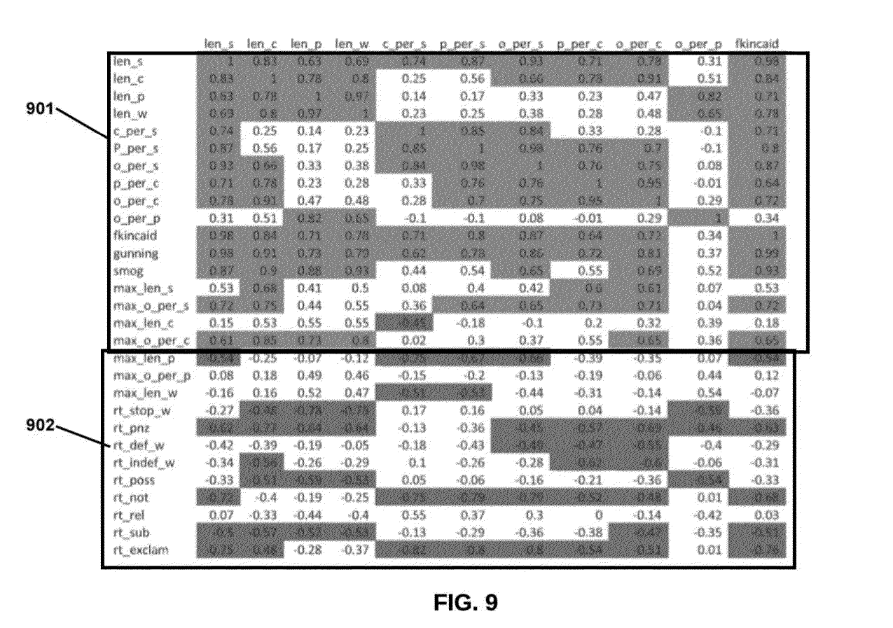

An example of correlations can be seen in the sample metrics table is illustrated in FIG. 9. Structural elements, readability, and other discourse metrics that are positively correlated are surrounded by a box 902 (marked in green in the drawing), while metrics that are negatively correlated are surrounded by a box 904 (marked in red in FIG. 9), with data points shown in FIG. 9 without coloring indicating a lack of correlation, either positive or negative. Both the rows and columns consist of structure, readability and other discourse metrics taken from a corpus of documents in order to find correlations, either positive or negative, among specific metrics. For example, in row one, length of sentence (“len s”) has a large positive correlation with a higher readability score (“fkincaid) at 0.98, creating a positive correlation between these two metrics. Additionally, having a higher maximum length of phrases (”max len p″) creates a negative correlation with readability (“fkincaid”) at −0.45. What these metrics indicate is that a document with a high readability level is likely to have longer sentences, while a document with a higher maximum length of phrases is likely to have a lower readability level. Thus, the positive correlation between readability and sentence length could be used to help classify more complex documents, such as scientific or technical documents, while the negative correlation between maximum phrase length and readability could be used to classify more simplistic documents, such as text from social media. However, one skilled in the art will appreciate that these are merely examples of how the metrics may be used, and these examples do not limit the system and method to these particular metrics, or any other groups of metrics, to be used as markers for any particular style or genre of document.

Metrics may be applied to the tokens in order to identify correlations, which form the basis for defining genres. Four patterns of communication serve as the foundation for the applied metrics: readability; structure (and rhythm); discourse; and the quality and originality of the content. Readability refers to one or more commonly used formulas to evaluate the reading comprehension difficulty of a text, including but not limited to: Flesch Reading Ease, Flesch-Kincaid Grade Level, Automated Readability Index, Colemen-Liau Index, Gunning Fog Index, and the SMOG Index. Structure refers to the physical fragmentation of the document (e.g., physical segments of phrases clauses and sentences) and its logical articulation (e.g., grammatical words such as prepositions, conjunction and pronouns; and distance markers such as quotation, colon, parenthesis and brackets). Discourse refers to the unfolding of one or more stories and the vantage points which are made available for the reader. Typically, an author's personal take on an event is discourse, making the figurative “distance” between the author and the viewer narrower than that of other vantage points, such as narrative.

Content originality refers to the relative “fullness” v. “emptiness” of the content, while content quality refers to the nature of the concepts or the quality of the context. To determine the relative fullness or emptiness of content, several different metrics are tracked. First, the ratio of non-grammatical words is tracked. Then, a frequency threshold in implemented (e.g. first 1,000 most frequently used words of “Web” English). Next, words which are not listed in WordNet are counted (i.e., words that have typos, qualify as a technical reference, are creative, etc). After, the height of the word's category in the WordNet hierarchy is measured, with a threshold level of 8. Lastly, the known idioms are counted. Non-grammatical words may include words containing a typo, creativity, a technical reference, a foreign lexicon, etc.

To determine the quality of content with regard to the nature of the concepts, the ratio of named entities (either listed or inferred from graphic signs, such as the use of uppercase characters, use of periods, etc.) vs. common nouns is tracked along with facets: cognition, processes, etc. To determine the quality of the context, the amount of numbers, operators, symbols and special signs (e.g., currency) are tracked.

The first main group of metrics, readability, utilizes the three readability indices metrics groups: Flesch-Kincaid (shown as “fkincaid”), Gunning Fog (shown as “gunning”) and Smog (shown as “SMOG”). The readability score metrics can be combined with many other metric groups to identify correlations. For example, groups of metrics regarding structure and rhythm, such as the length and composition of text units, maximum values of levels of complexity, punctuation ratios per occurrences, etc., may be paired with a readability score to identify discriminatory correlations.

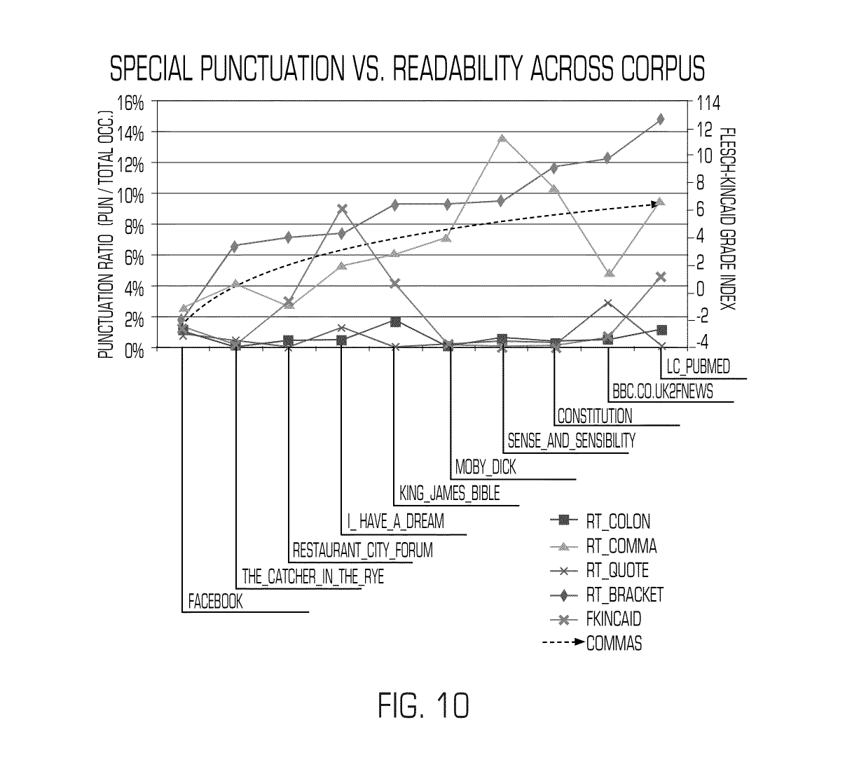

FIG. 10 illustrates how special punctuation markers are paired with readability (e.g., Flesch-Kincaid index). The trends illustrated in this particular graph demonstrate correlations between a higher ratio of special punctuation markers, such as commas, colons, quotes and brackets, and documents with a higher readability grade. For example, the document “k_pubmed” (an article from a scientific journal) has a readability score of 13 (fkincaid), and a higher ratio of brackets. In this particular context, brackets are used by a scientific text to introduce layers of additional references and observations. This correlation between a high reading level and a high ratio of special punctuation markers may be used as a correlation to define a particular writing style.

In yet another embodiment, readability metrics are paired with discourse markers in order to define correlations. Discourse markers are types of linguistic markers that indicate the amount of distance between a reader and author. There are multiple types of markers, including personal pronouns, proximity of deictics (e.g., determiners, markers of time and place), possessive forms, qualifiers (e.g., adjectives, adverbs, modality), sentiments and emotions, argumentation markers, emphasis tropes, and time and aspect markers. These markers may be tracked by parts-of-speech metrics, which consist of tracking which part of speech category each token fits into.

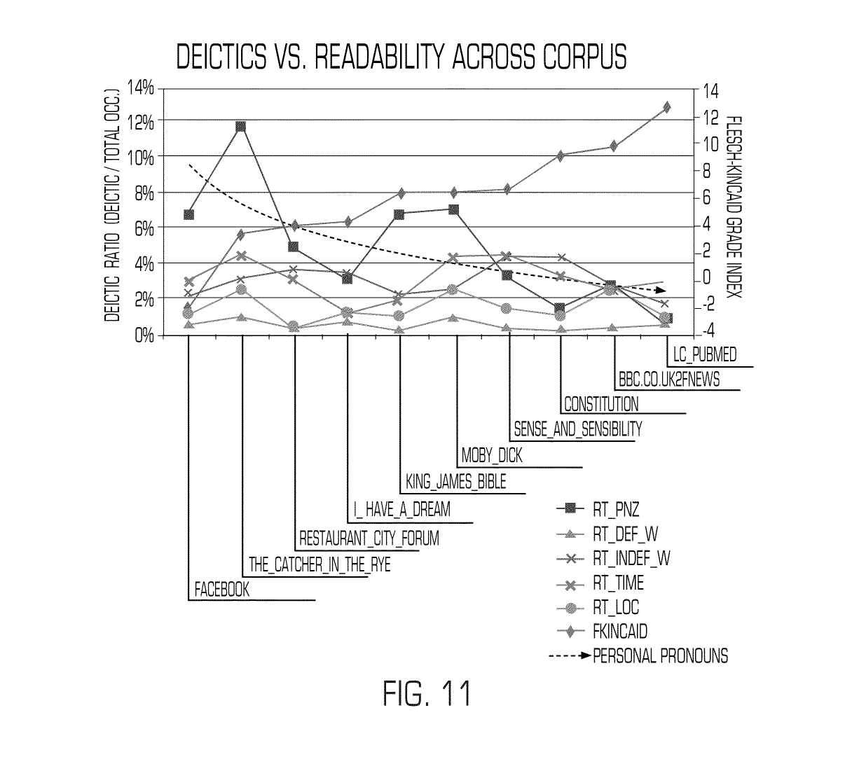

FIG. 11 illustrates how one of the discourse subgroups, deictics, is paired with readability metrics to illustrate correlations between the two groups. This particular subgroup contains several metrics: the ratio of personal pronouns (“rt_pnz”), the ratio of definite determiners (“rt_def_w”), the ratio of indefinite determiners (“rt_indef_w”), time (“rt_time”), location markers (“rt_loc”) and personal pronouns. The implication of the subject into the enunciation process, which is one of the cornerstones of discourse definition, is negatively correlated to complexity. Thus, when the content ratio rises, as in scientific, news and legal documents, the subject of enunciation fades behind neutral information delivery. Additionally, location markers are closely correlated to personal pronouns, with definite determiners follow the same pattern to a lesser extent. Also, the level of location markers in the news genre is high, given that the nature of news demands a discussion of location. Other subgroups of discourse metrics, such as qualifiers, semiotics, posture markers, etc., may also be paired with readability metrics in order to find correlations that may serve as determinative markers of one or more styles.

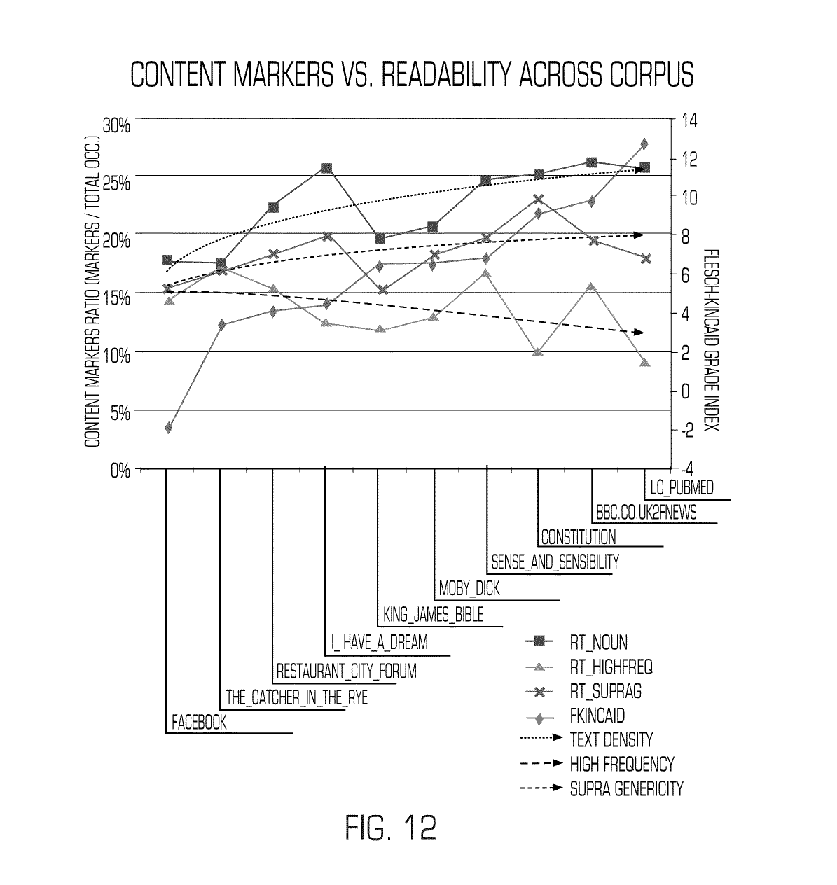

The next main group of metrics, content metrics, may also be paired with readability to find correlations, which is illustrated in FIG. 12. Content markers include the ratio of nouns (shown as “rt_noun”), the ratio nouns with a high frequency (“rt_highfreq”), the ratio of supra-generic categories (“rt_suprag”), text density, the amount of high frequency words, and the amount of supra-genericity. The defining markers of content are nouns, which are about conditions and cognition. Other markers of information may also be correlated: vocabulary of cognition, named entities (bibliography, products), acronyms, and compound nouns. Processes and supra-generic categories are correlated, as opposed to condition and cognition concepts, which are more specific. Additionally, the graph illustrates the two sides of originality: on the one hand, low frequency is correlated to quality content, on the other hand, unknown words are correlated to conversational patterns: offensive speech, idioms, and basic English (e.g., high frequency words).

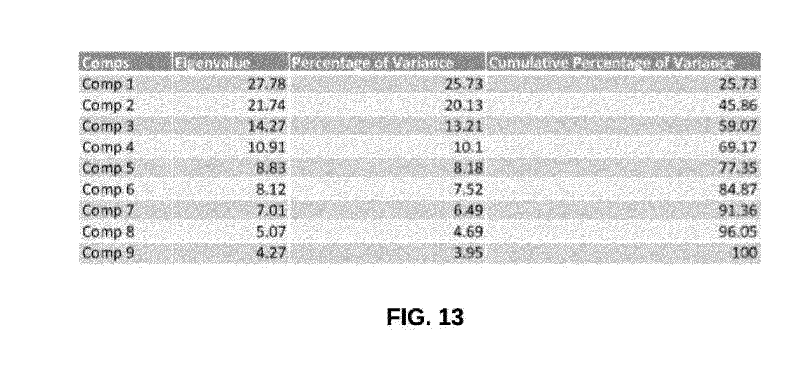

Once the metrics correlations are collected, they can be grouped and used to define one or more writing styles that will be utilized to categorize and index documents. FIG. 13 illustrates the resulting table from applying a principal component analysis (hereinafter “PCA”) framework in order to define features of different writing styles and genres to be leveraged in classifying and indexing like documents. PCA may be accomplished by using one or more “R” packages (e.g., FactoMineR). Columns and metrics in the PCA table are referred to as “variables”, while rows and documents are referred to as “individuals”. In the table shown in FIG. 13, the analysis has been performed on ten (10) individuals and 109 variables. Components in the PCA are obtained through the diagonalization of the correlation matrix, which extracts the associated eigenvectors and eigenvalues, interpreted as the “explained variance” for competitors. The main input parameters of the PCA function are the data set (standardized) and the position of the categorical variable in the data set. In FIG. 13, the results correspond to the eigenvalue associated with each of the components, the percentage of inertia associated with each component and the cumulative sum of these percentages.

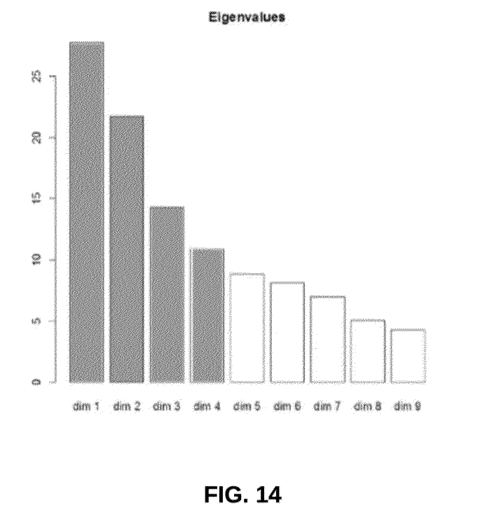

FIG. 14 illustrates the first four components of the eigenvalue percentage table are shown graphically. The first two main components of viability summarize 46% of the total inertia (i.e., 46% of the total viability of the cloud of individuals is represented by the plane). The first four components, dimensions 1, 2, 3, and 4 (shown as “dim 1”, “dim 2”, “dim 3” and “dim 4”), explain 70% of the cloud. The cloud of individuals representation is a default output of the PCA function.

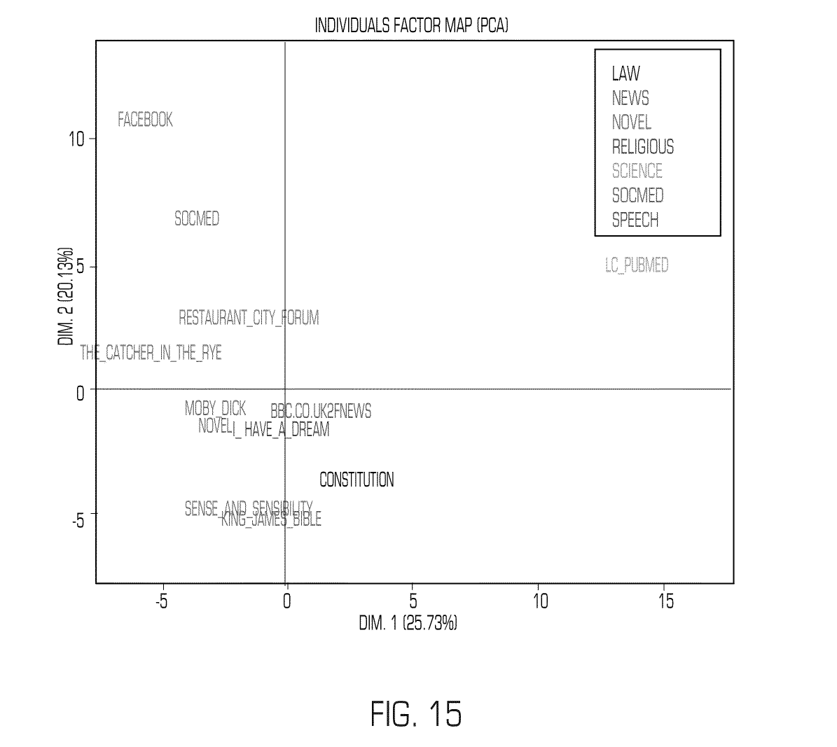

These dimensions can be used to created factor maps that demonstrate the relationships between the correlations that are unique to one or more documents in a corpus. In FIG. 15, the first two eigenvalue components (“Dim 1” and “Dim 2”) are used to map a corpus of sample documents, illustrating how they are related. The corpus of documents used for mapping includes a wide variety of document types: legal text (“constitution”), news (“bb.co.uk2fnews”), novels (“catcher_in_the_rye”, “moby_dick_novel”, “sense_and_sensibility”), religious text (“King_james_bible”), scientific text (“lc_pubmed”), social media text (“facebook”, “SocMed”, “restaurant_city_forum”) and speech text (“i_have_a_dream”).

The first component (“Dim 1, 25.73%”) illustrates a negative correlation between content level and conversation level. Scientific text (“PubMed”) has a high quality of content and density of information: the text has a high readability grade level; quality content by virtue of a high amount of named entities, acronyms, processes, conditions and cognition topics; discourse flow; and text density, with many nouns and non-stop words ratio. This is opposed to social media (“Facebook”®), which is high in conversational discourse: there is a high amount of deictics, such as personal pronouns, possessives, indefinite determiners, and quantity markers; a low text density with a high frequency of words and grammatical words ratio; a high level of discourse markers, such as posture markers stative verbs, copulas, negotiation markers, logical connectors; emphasis patterns, such as interrogation marks, exclamation marks, suspensive marks and graphic effects; and a high level of controversy, measured by the amount of offensive words and negation. This first group of variables draws the first principal component and the overall score. The first principal component is the combination that best sums up all the variables.

The second component (“Dim 2, 20.13%”) illustrates a negative correlation between conversational discourse and structural complexity. Social media (in this case, “Facebook”) is high in conversational discourse (complete with the same markers as listed above). This is opposed to the King James Bible (religious text) and Sense and Sensibility (novel), which have a high level of structural complexity, which includes a high ratio of occurrences, phrases and clauses per sentence; a high ratio of relative pronouns; and a high ratio of participles (which is a marker of narrative).

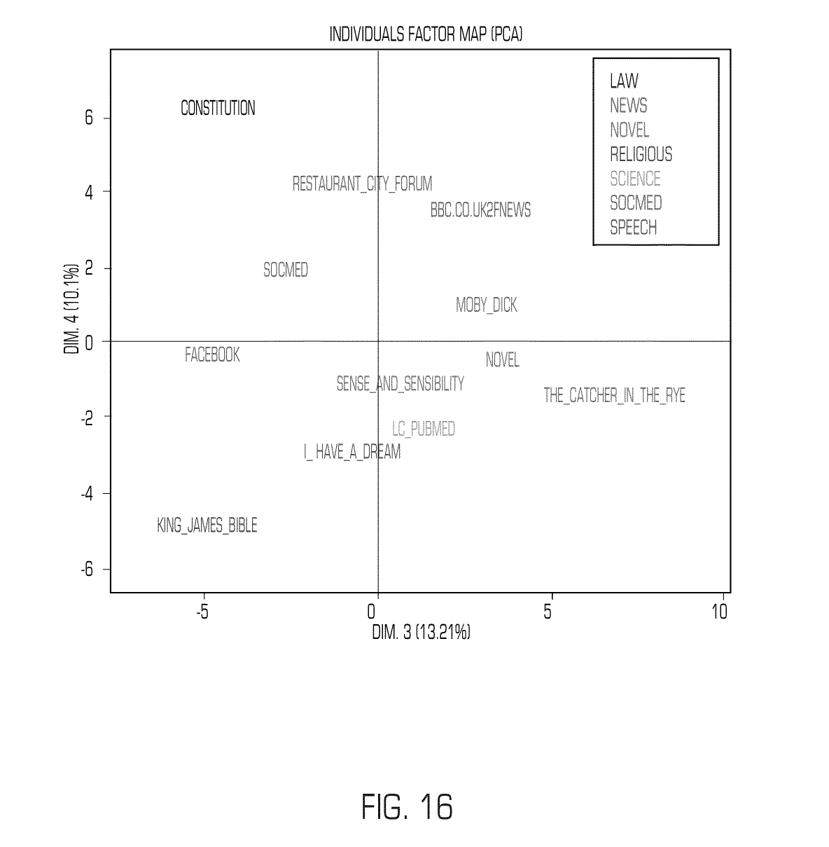

The next two eigenvalue components (“Dim 3” and “Dim 4”) are illustrated on a factor map, shown in FIG. 16. The third and fourth components (“Dim 3” and “Dim 4”) draw a negative triangular correlation between Catcher in the Rye, the Constitution, and the King James Bible. Component three is well defined around an emotional narrative genre, which embodies Catcher in the Rye: there exists a high level of deictics, which includes a high level of definite words and location markers; the novel is high in qualifiers and intensity, with a high ratio of adjectives and a high ratio of adverbs; there is also a high level of emotions, including antagonism (the ratio of negative forms) and a high ratio of emotions; additionally, there is a high level of logical complexity, which includes a high ratio of logical connectors; also, there exists a high level of basic English, including idioms; and lastly, a high level of past forms of tenses and past progressive forms.

The fourth component contains a negative correlation between law (the Constitution) and the Kind James Bible (which comprises an entire genre by itself). The Constitution is high in modality (defining the upper limit of modality in the corpus); high in structural complexity (length of phrases, number of occurrences per phrase, ellipsis); high in deictics; high in entities; high in “enthusiast style” (ratio of “SPNB semiotic markers and intensity markers); and high in qualifiers, passive participle tenses and content quality. Additionally, the King James Bible is high in specific punctuation (colon and parenthesis), ethics (i.e., the ratio of sentiments), past forms and past participle forms of tenses, negative forms and entities. What all of these metrics indicate is a major discrimination in content vs. discourse, and that a variety of theses metrics may be used to find discriminatory correlations of more nuanced styles.

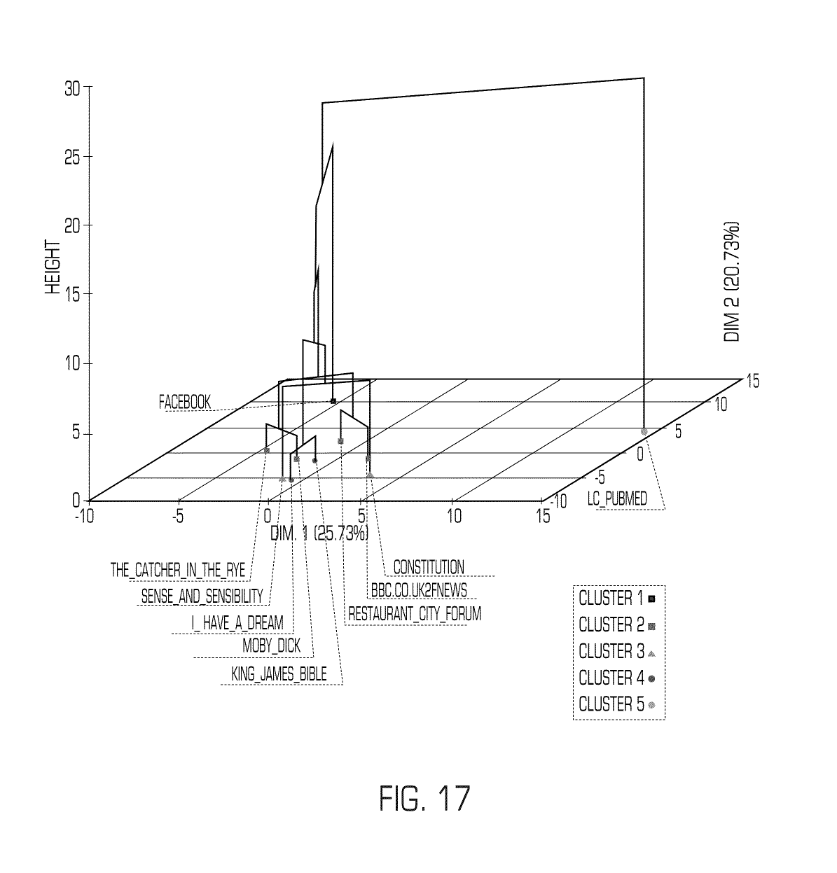

FIG. 17 provides another view of the clustering of corpus documents on the individual factor map. The major discrimination between content and discourse is illustrated in a three-dimensional view. The first two components (“Dim 1, 25.73%” and “Dim 2, 20.13%”) are shown along the bottom of the graph and the right side of the graph, while the height is shown along the left side of the graph. Cluster 1, represented by the color black, contains “facebook” (social media), which anchors one end of the spectrum, while “k_pubmed” (scientific text), shown in Cluster 5 (light blue), anchors the other end of the spectrum. With these two distinct writing style serving as the boundaries, the rest of the corpus falls into either Cluster 2, 3, or 4 in between Clusters 1 and 5.

While collected documents are put through writing style analysis, the semiotic analysis and mapping system and method described in this disclosure also performs in depth tone analysis on the same collected documents in order to recommend documents to users based on their tone in which the documents are written.

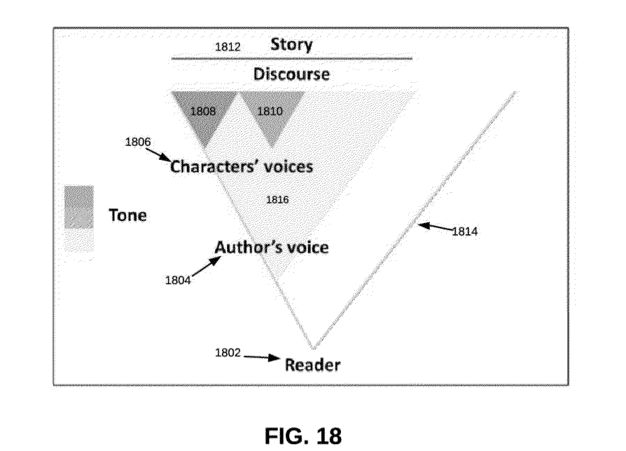

The writing tone of a particular document, as used in this disclosure, may be viewed through the lens of inter-subjectivity, illustrated in FIG. 18. Literary texts often convey multiple ‘voices’ (e.g. different characters' voices, author's voice, etc.). Together, the layered voices of the characters coupled with that of the author creates a tone for the text. The diagram in FIG. 18 illustrates a reader's perception of the tone of a story. The reader 1802 is represented as the broadest view, while the author's voice 1804 is represented by the yellow triangle within the reader's perception, and the characters' voices 1806 are represented by the orange 1808 (a particular character) and green triangles 1810 (another character) within the author's voice. By layering these entities, the reader is able to perceive the overall tone 1814 of the story 1812. FIG. 18 illustrates the concept that everyone tone needs a voice in order to be conveyed (represented here by the character and author voices), and every voice has a different tone that when combined, creates an overall tone for a story.

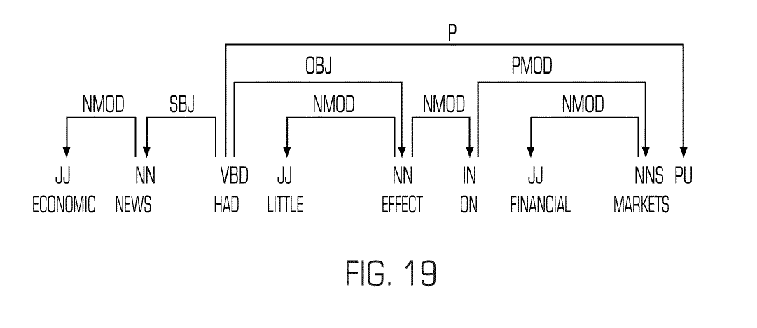

In order to surface the tone of a story, isotones may be created based on extracted information surfaced during dependency grammar parsing. FIG. 19 illustrates dependency grammar parsing performed on the sentence, “Economic news had little effect on financial markets.” Each word is given a part-of-speech tag: adjective (JJ), noun (NN), past tense verb (VBD), preposition (IN), plural noun (NNS), and punctuation (PU). The dependency relationships in this sentence are represented by directional arrows, and consist of prepositions (P), object (OBJ), subject (SBJ), noun modifiers (NMOD) and preposition modifiers (PMOD). These are the type of relationships that will be tracked and leveraged into dependency graphs that serve as the basis for defining isotones.

Leveraging dependencies into isotones consists of identifying the different dimension orientations of each sentence in a document (known in linguistics and hereinafter as “Deixis”). Deixis is one of the fundamental dimensions of the semiotic square. There is one “positive” deixis, and one “negative” deixis. The deixis is a posture “for” and “against”, to emphasize that the two “sides” of the basic semiotic square are exclusive and potentially argumentative. The deixis is not only a certain value and a certain orientation, it is also a statement which may be supportive or adverse. The deixis height is described by its orientation, and is modulated by its intensity.

Measuring deixis height consists of measuring the relative orientation—positivity, negativity or satirical—of each sentence. This is accomplished by using dependency grammar parsing at several structural levels: the phrase level, clause level and sentence level. This type of parsing creates dependency graphs which surface named entities, topics and sentiments to be latched into a taxonomy containing the same or similar named entities, topics and sentiments. An isotonic isotopy/isotone (which is leveraged to create a tone profile for the document as a whole) may be defined by the reoccurrence of the following features: deixis orientation, deixis intensity and semiotic category associated with that deixis. The information surfaced by the dependency graphs allows the deixis height to be measured for each sentence by tracking the frequency of latched sentiments, and whether the sentiments are positive, negative or satirical. The frequency of sentiments contained in each sentence determines the deixis orientation and intensity of that particular sentence. The number of positive, negative and satirical sentences are counted, and these numbers determine the tone profile for the document as a whole. This tone profile allows the document to be indexed and linked to documents with similar latching, entity and sentiment profiles.

The same sample document used for writing style analysis, illustrated in FIG. 6, is used to demonstrate how an isotone profile is formed for a particular document. It is important to note that in this particular document there is a recurrence of several series of semantic values across the sentences: sexual attractiveness, intellect, urban affiliation, spiritual affiliation, and music genre affiliation. The latter is a mix of several sub-isotopies: soul music, gospel, crooner style, classical, and R&B. In the same article, we also note that these isotopies are isotonic: sexual attractiveness is sarcastic, intellect is laudative, urban is derogatory, spiritual is neutral/positive, music (e.g., soul music, classical, R&B, etc.) is laudative, and music (e.g., modern, R&B, etc.) is also derogatory. These isotopies are correlated across the article illustrated in FIG. 6, and these correlations can be measured by the distance of their isotopes/isotone members within the same dependency graphs.

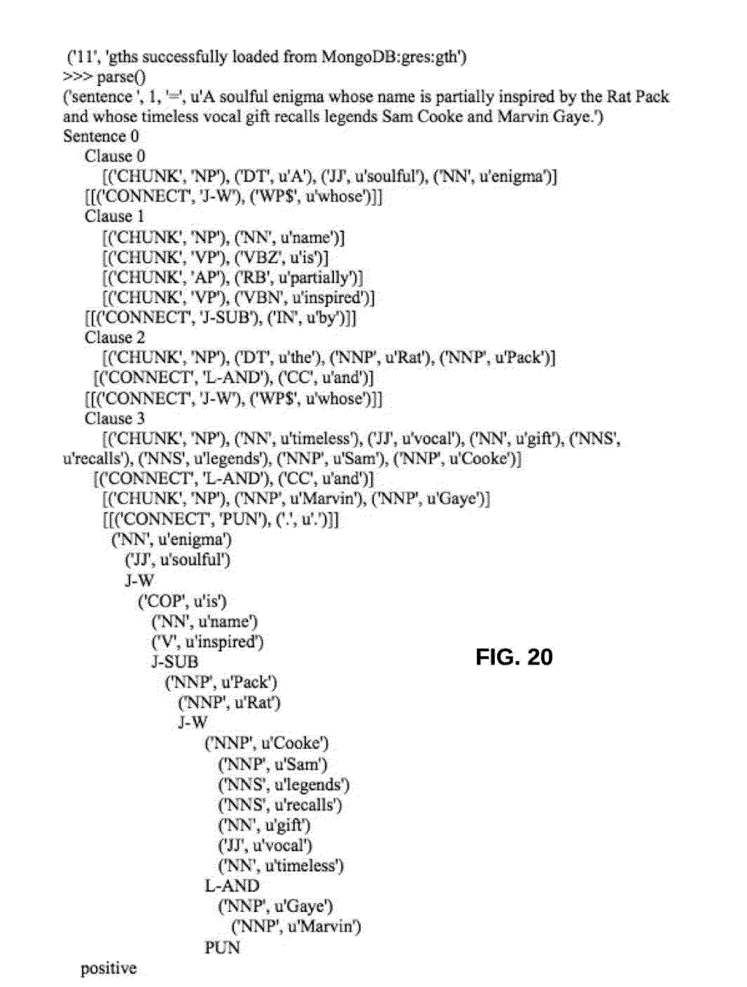

FIG. 20 is an excerpt from a trace performed on the document in FIG. 6 in a sample database. The particular database used for this trace is Mongo DB, but this example is not mean to limit the systems and methods disclosed to any particular database system. The first sentence of the article, “A soulful enigma whose name is partially inspired by the Rat Pack and whose timeless vocal gift recalls legends Sam Cooke and Marvin Gaye,” is parsed using dependency grammar parsing. Each clause (of which there are three total) of the sentence is broken down into noun phrases (e.g, “soulful enigma” in Clause 1, “Rat Pack” in Clause 2, etc.). These noun phrases and any entities or topics also included, are latched into the appropriate facet, concept, header, phrase and frequency (e.g., the named entity “Marvin Gaye” would be latched into the facet of “R&B”, the concept of “R&B”, the header of “Marvin Gaye”, the phrase “Marvin Gaye”, and the because the noun phrase occurs twice in the article, a frequency of “2”). After latching, the deixis height for each sentence is measured, and a determination is made for that sentence. In this particular sentence, the deixis orientation is positive, thus the sentence is counted as a positive sentence. This sentence, along with all other positive and negative sentences, will be used to define an overall tone for the document. The numbers of positive and negative sentences indicate different tones. The end of this process results in development of a document tone profile consisting of latches to entities, topics and sentiments contained in a taxonomic thesaurus (known throughout the rest of the disclosure “gth”), to be used to group this document with similar documents.

In addition to analyzing, mapping and recommending content to users based on the style or tone in which the content is written, content may also be recommended based on creating semiotic personas for entities extracted from collected documents. These personas may be compared to determine how semiotically related two entities are. Thus, if a user has a preference for a particular entity, the semiotic analysis and mapping system and method may use semiotic relatedness to recommend content items containing similar entities to users. Semiotic personas are formed by extracting and aggregating patterns of communication (which may take the form of stories, sentiments, quality, style, tone, etc.) around entities. These patterns of communication are known as isotopies, which are defined as longitudinal studies of topic markers. By aggregating and clustering isotopies around entities, the semiotic of that entity begins to take shape. These personas are leveraged into content recommendations for users.

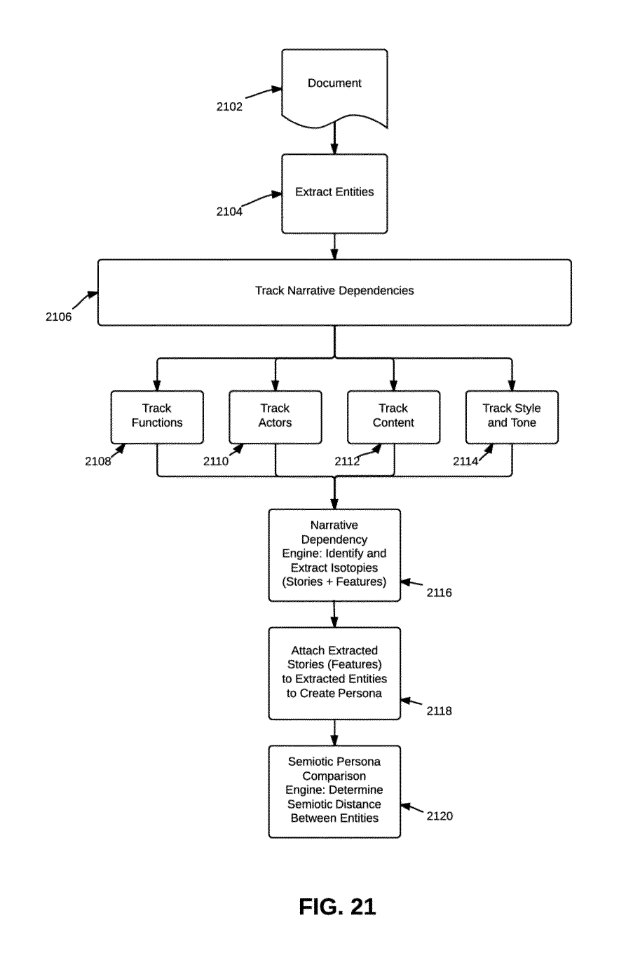

The process of creating and comparing entities' semiotic personas is illustrated in FIG. 21. Entities are extracted 2104 from a given document 2102. Narrative dependencies are extracted and tracked 2106 through dependency grammar parsing. Within the process of tracking narrative dependencies, functions 2108, actors 2110, content 2112, and style and tone 2114 are tracked. These dependencies are used to identify and extract isotopies 2116 (stories, semiotic patterns, semiotic features, etc.). These extracted isotopies are attached to the corresponding entity, forming the entity's semiotic persona 2118. Entity personas can be mapped in order to compare any two given entities 2120. The semiotic distance between two given entities, based on the relationships of the mapped semiotic features comprising the entity's profile, can be leveraged in order to recommend context indexed according to this semiotic distance.

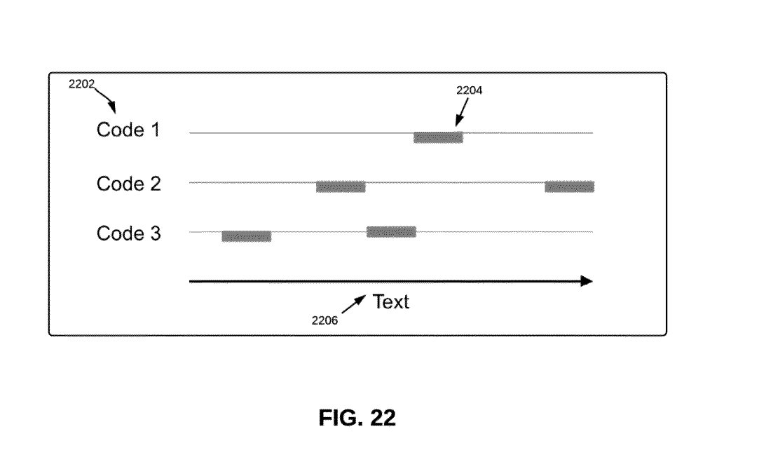

Isotopies are illustrated in more detail in FIG. 22. An isotopy is longitudinal study of topic markers, i.e., a correlational study that involves repeated observations of the same semiotic markers across a series of utterances. The isotopy gives homogeneousness to the recital's sequences. Once the isotopy has been created, the semantic and semiotic traits marked by this isotopy will develop structural codes chronologically. The codes 2202 are represented as horizontal lines. Examples of codes include topology, time, color, cultural affiliation, violence, etc. The markers 2204 contained in each code identify a corresponding word in the text 2206. These markers define the isotopy code, which in turn will define the semiotic persona of an extracted entity.

Once the isotopies are extracted, they are attached to entities contained within the given document. After attachment, these isotopies become part of the semiotic persona of the given entity, following the entity through any recommendation or relevance process. This system and method allows for mapping of consistent correlations between entity features and personas to be leveraged into content recommendations through clustering groups of entities with specific persona features in common.

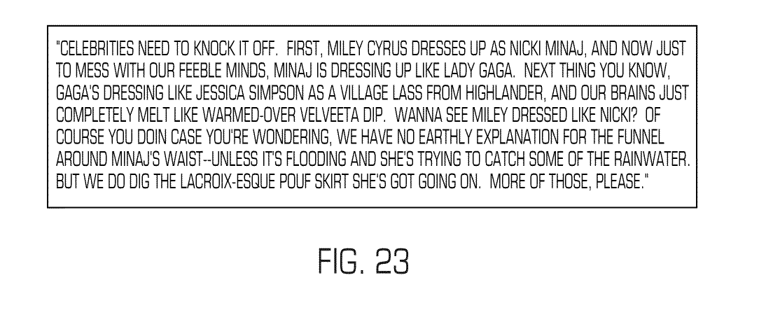

To demonstrate how isotopies are extracted and aggregated to form semiotic personas for entities, a sample document is shown in FIG. 23. The document is collected and then analyzed through dependency grammar parsing, extracting entities and isotopies to form entity semiotic personas. This document will be indexed according to the semiotic personas of entities contained in the document. This particular collected document is an article involving the entity “Nicki Minaj”, and will be indexed according to her semiotic persona.

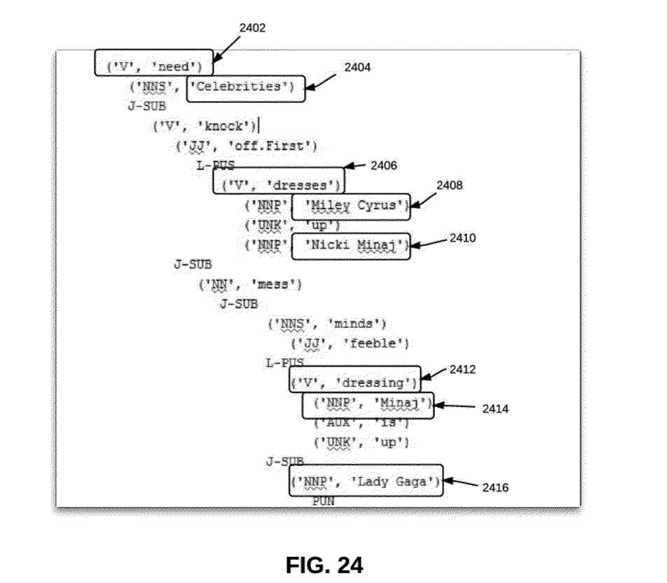

Dependency grammar parsing, performed on the article shown in FIG. 23, is illustrated in FIG. 24. This type of parsing surfaces narrative dependencies that will characterize isotopies, which are then used to create a semiotic persona for a given entity contained within an article or document. Creation of an entity persona allows for comparison between a plurality of entities through the mapping of features belonging to each persona. Here, dependency grammar parsing starts by identifying the verbs in each sentence, then identifying entities, arguments and functions attached to the verb. These entities, arguments and functions define features of the entities contained in the article and they are used in the entity map to be leveraged into isotopies. Thus, in this example, the verbs ‘need’ 2402, ‘dresses’ 2406, and ‘dressing’ 2412 are the entry points for parsing. Attached to each of these three verbs are entities, arguments and functions. For example, the entity ‘Celebrities’ 2404 is attached to the verb ‘need’ 2402, the entities ‘Miley Cyrus’ 2408 and ‘Nicki Minaj’ 2410 are attached the verb ‘dresses’ 2406, and the entities ‘Lady Gaga’ 2416 and ‘Minaj,’ 2414 are attached to the verb ‘dressing’ 2412.

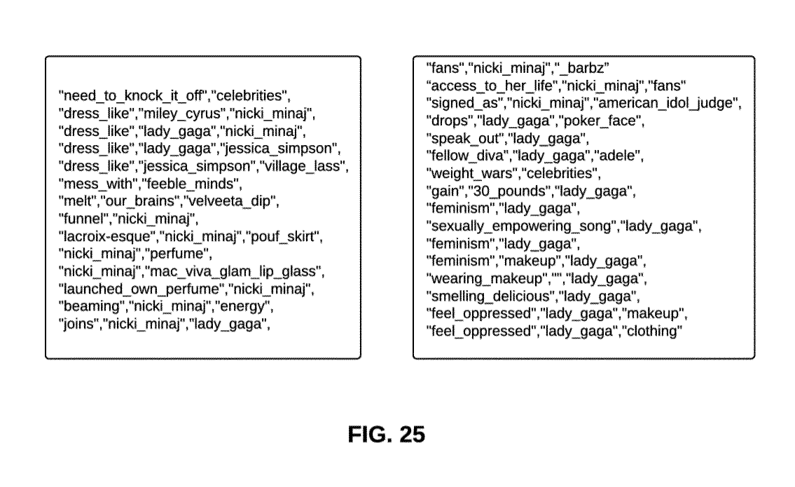

The narrative functions, entities and verbs surfaced through dependency grammar parsing demonstrated in FIG. 24 are listed in FIG. 25. These functions are extracted from the sample text and then mapped with their corresponding entity in order to gauge the semiotic distance between two given entities. Entities that share features will be clustered more closely together on the map. The isotopies across the narrative functions identified here are illustrated in FIG. 26. These extracted narrative functions are grouped by their semiotic markers in order to form different isotopy patterns. For example, the word “Lacroix-esque” is a marker of fashion 2604, which along with the function of “Cosmetics” 2606 and “American Idol” 2608 forms the isotopy pattern of “Brands” 2602. Other isotopies, such as “Feminism” 2610 and “Sexuality” 2612, are also formed through the extraction of entities and functions from the text. These isotopies will comprise the semiotic persona for the entity Nicki Minaj, and can be compared to the semiotic personas of other entities contained in the article, such as Lady Gaga.

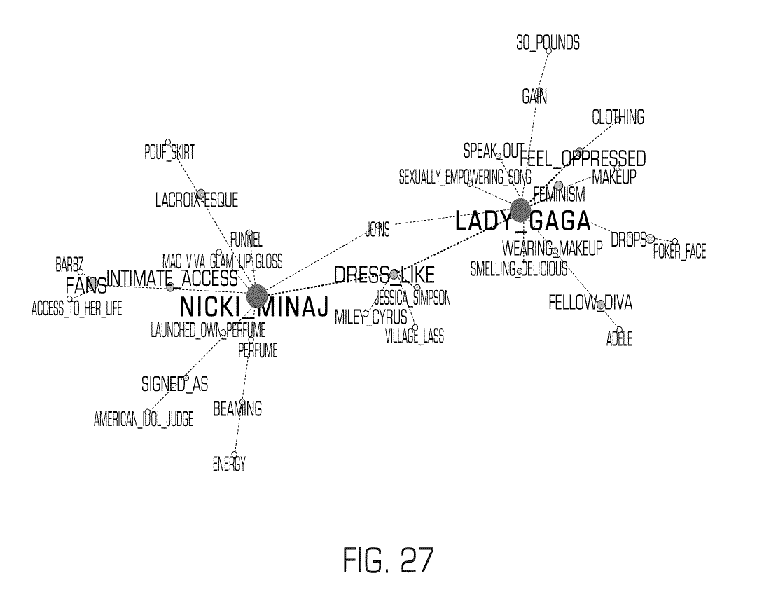

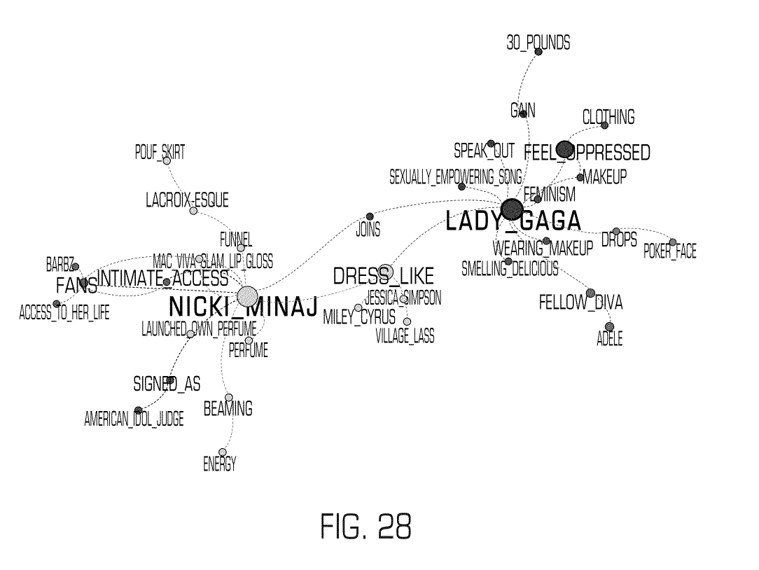

Entities and their extracted semiotic features are mapped in order to demonstrate semiotic distance, illustrated in FIG. 27. This map is comprised of nodes of varying size (indicating the weight of connections), representing entities and features of entities, with edges showing the connections between entities and their features. The two entities being compared in this particular example, Nicki Minaj and Lady Gaga (extracted from the article shown in FIG. 23 along with other articles in a sample corpus), comprise the largest nodes on the map, while their features comprised smaller nodes. The features that the two entities have in common, such as ‘dress like’, demonstrate the semiotic distance between the two entities. Connections between the features of entities are used to index articles and other documents. Another view of this data is shown in FIG. 28, which illustrates the same entities and features as FIG. 27, but this particular map demonstrates how semiotic features are clustered around entities. The different colors of the nodes and edges represent the different entity/feature clusters. The semiotic proximity of these clusters can be leveraged into recommendations by indexing content around the proximity of the clusters. For example, the feature node “dress like” links the entities Nicki Minaj and Lady Gaga, along with other entities such as Jessica Simpson and Miley Cryus. The semiotic proximity of the entities can be used to index like documents to be leveraged to recommend content to users.

In addition to writing style, writing tone, and semiotic personas, extracted semiotic stories may also be included in the semiotic analysis and mapping system and method described in this disclosure. In one embodiment, semiotic stories are extracted from a plurality of articles through dependency grammar parsing, which extracts narrative dependencies and couples the dependencies with writing style and writing tone to define and characterize semiotic stories.

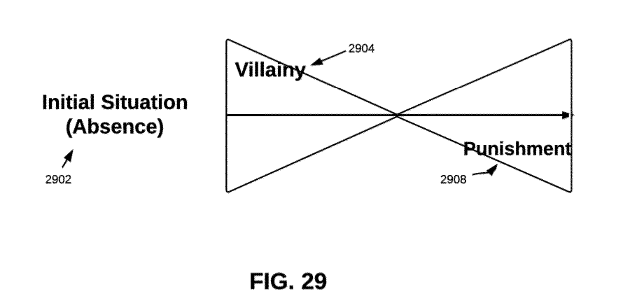

Narrative dependencies may be comprised of narrative functions, actors, isotopies and writing style and writing tone. Narrative functions, such as the function illustrated in FIG. 29, consist of a specific attribute or action of a character in a narrative. Here, a semiotic model of an exemplary narrative function is illustrated, which consists of an Initial Situation 2902 that is modified by a knowledge transfer between two elements. In this case, the elements consist of Villainy 2904 and Punishment 2908. This function demonstrates a high-level, fundamental relationship between these two polarities. Narrative functions are surfaced through dependency grammar parsing and help characterize semiotic stories.

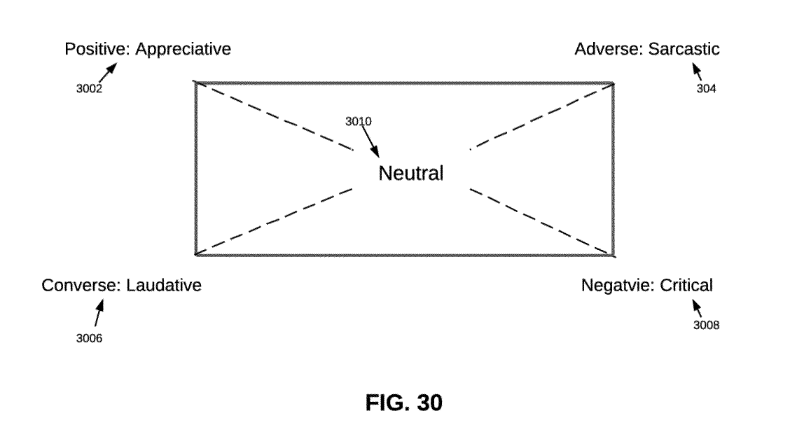

In addition to narrative functions, writing style, writing tone, and actants are also extracted. Actants are high-level, fundamental relationships between actors in a story. In FIG. 30, a semiotic model is shown with style and tone polarities. Defining the outer limits of the square model are four polarities: positive, appreciative 3002 sitting opposite negative, critical 3008; and Converse, Laudative 3006 sitting opposite Adverse, Sarcastic 3004. As these boundaries are the outer limits of communication postures, a figure of style that is mapped near the middle is considered neutral 518. This square helps illustrate what posture orientation a figure may have and how that orientation is related to the posture orientations of other figures in order to define the style and tone of text.

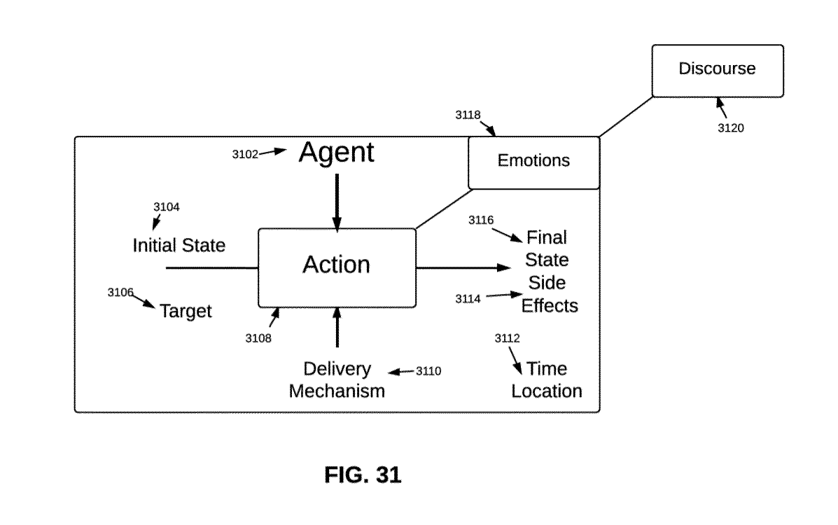

FIG. 31 illustrates a semiotic dependency model used to define and extract narrative functions, which in turn are used to define semiotic stories. This semiotic dependency model structure is surfaced through dependency parsing. The narrative function is mapped with the all of the different features comprising the function. Here, there is an Initial State 3104 accompanied by a Goal or Target 3106. The Initial State is altered through an Action 3108 of the Agent 3102 and accomplished through a Delivery Mechanism 3110. The end result of the action is a Final State 3116, with all the residual Side Effects 3114 of the Action 3108. The Action 3108 also surfaces Emotions 3118, which in turn give rise to Discourse 3120. Tangentially related to the Action 3108 is the Time and Location 3112 of the Action 3108. By breaking articles down into the above narrative function elements, the structure of a story is quickly surfaced, no matter what the content of the article or document. These narrative dependencies and the dependency models they comprise help identify stories in any type of text, whether it is a product review, a short story, or a news article.

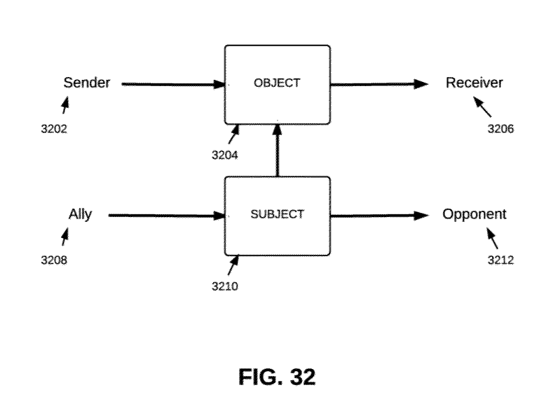

FIG. 32 illustrates another aspect of semiotic dependency parsing to be used to help surface semiotic stories. In addition to the semiotic dependency model described above, an actantial model (e.g., another form of a semiotic model) is used to surface high-level, fundamental relationships within a story. Typically, these high-level relationships have to do with power, desire or a knowledge transfer. Here, a generic actantial model is shown. An Object 3204 is sent between a Sender 3202 and a Receiver 3206. More specifically, this object may be the Subject 3210 of a power struggle between and Ally 3208 and an Opponent 3212. Or, it may be a knowledge transfer of some kind. These actantial relationships can be leveraged to define and shape semiotic stories.

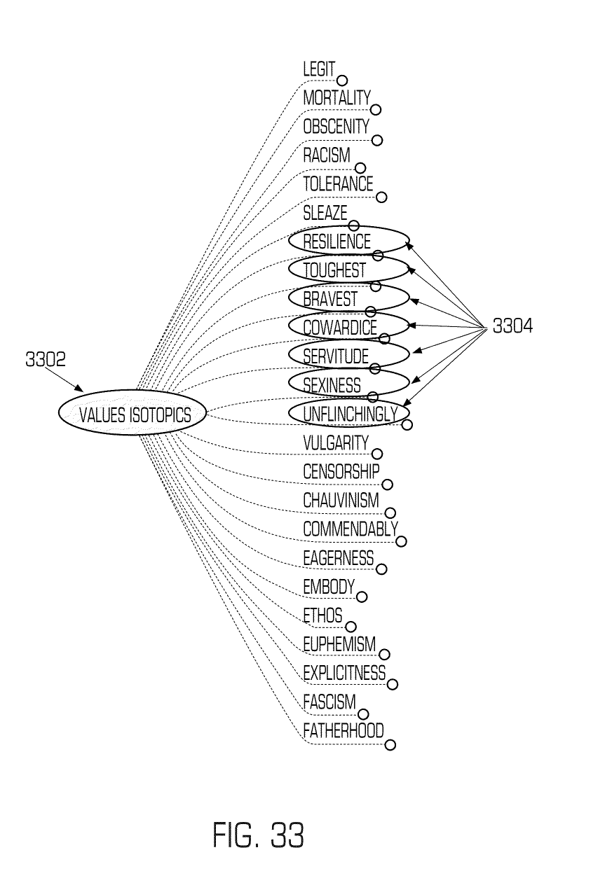

Once markers and isotopies have been extracted the can be used to form semiotic stories. Additionally, they can be used to construct one or more ontologies to be leveraged into recommendations. FIG. 33 illustrates an excerpt of an ontological map of various isotopies and their relationships to other isotopies. Here, the category of values isotopies 3302 is shown. Many different isotopies 3304 comprise the category of values, including resilience, toughest, bravest, cowardice, servitude, sexiness, unflinching, etc. This illustration is merely an example of one of a plurality of isotopy categories.

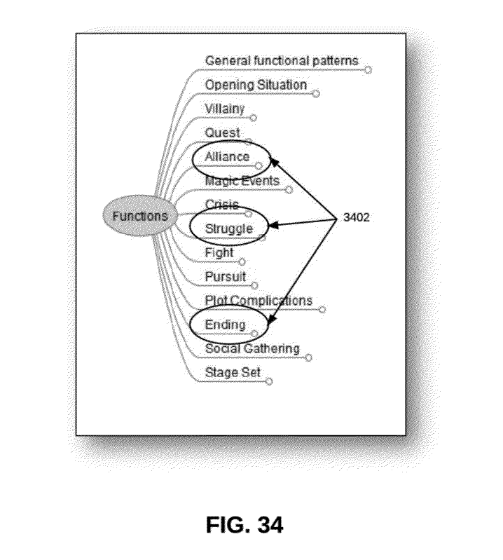

In addition to an isotopy ontology, ontologies may be created for other narrative dependencies. FIG. 34 illustrates an excerpt of an ontological map showing various narrative functions which are extracted and define various semiotic stories. Here, a plurality of functions 3402 are shown, including alliance, struggle, ending, etc. Again, narrative functions illustrate a specific attribute or action of a character in a narrative. Functions help define and identify semiotic stories by identifying certain fundamental, high-level relationships contained in narrative, and the function ontology can be leveraged to make content recommendations to users.

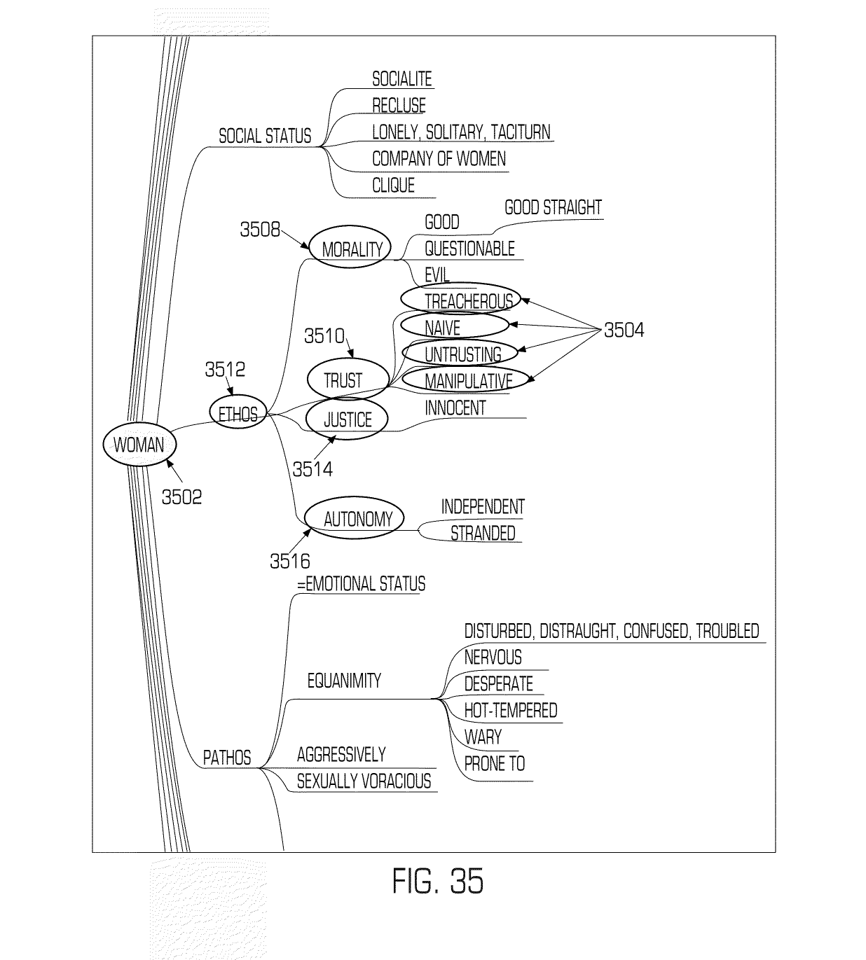

A snapshot of an ontological map of various actants to be extracted from articles and used to define semiotic stories is illustrated in FIG. 35. Here, a plurality of categories and subcategories comprising the umbrella category of Woman 3502, is illustrated. Each subcategory is further broken down in order to create many different types of actants that can be used to identify semiotic stories. For example, the subcategory of Ethos is broken down into Morality 3508, Trust 3510, Justice 3514 and Autonomy 3516 Each of these subcategories is broken down even further into more granular categories 3504, such as Treacherous, Naive, Untrusting, and Manipulative, comprising the subcategory of Trust 3510. By breaking down actants into granular categories, nuanced and complex semiotic stories can be identified and defined, and may be leveraged into content recommendations for users.

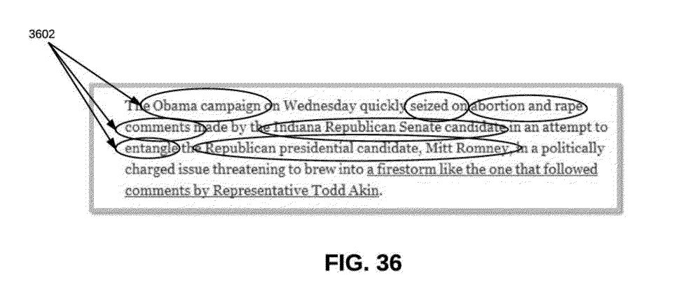

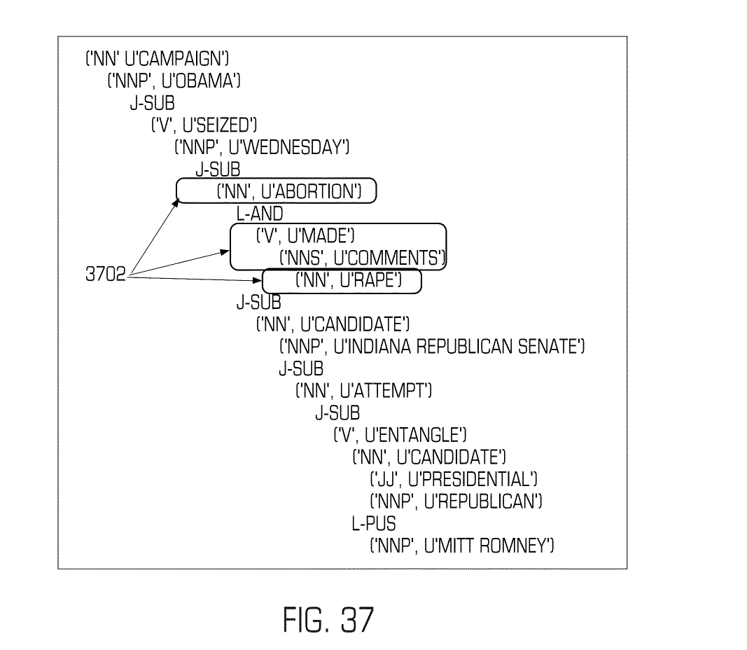

To demonstrate how semiotic stories may be extracted, a sample of a collected document is shown in FIG. 36. The circled terms 3602 serve as semiotic markers to be extracted and used as the basis for a semiotic story. In this excerpt from an article on the 2012 Presidential Election, the phrases “Obama campaign”, “abortion and rape”, “comments”, “Indiana Republican Senate candidate”, “entangle”, and “Republican presidential candidate, Mitt Romney” are extracted and used to form the semiotic dependency model. In FIG. 37, dependency grammar parsing is performed on this sample document. The entry point for dependency grammar parsing is through identification of the verbs 3702 in each sentence, then identification of the entities, the arguments and the functions attached to the verb. These entities, arguments and functions define features of the semiotic stories to be extracted from the article.

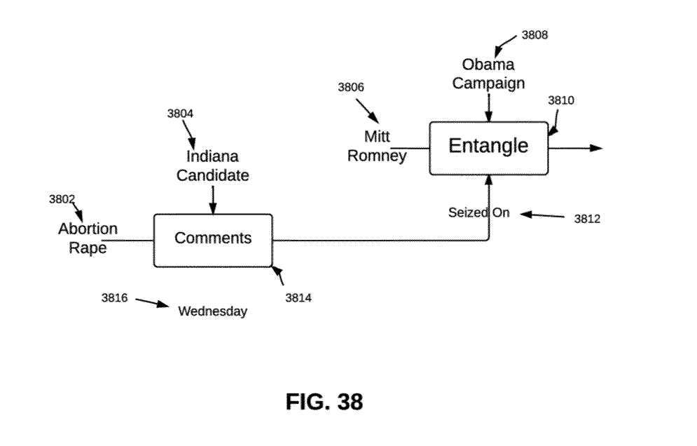

FIG. 38 illustrates a semiotic dependency model is formed from the extracted markers in FIG. 37. “Abortions and rape” 3802 serves as the initial state, the Indiana Candidate 3804 is the agent who delivers the action: Comments 3814. The final state of this action, Seized On 3812, affects a subsequent action delivered by a new actor 3808 (Obama Campaign) modifying a new situation 3806 (Mitt Romney) through action 3810 (Entangle). The dependencies comprising this semiotic story can be compared to other dependencies in other semiotic stories in order to define semiotic distance and relationships, which may be leveraged into content recommendations.

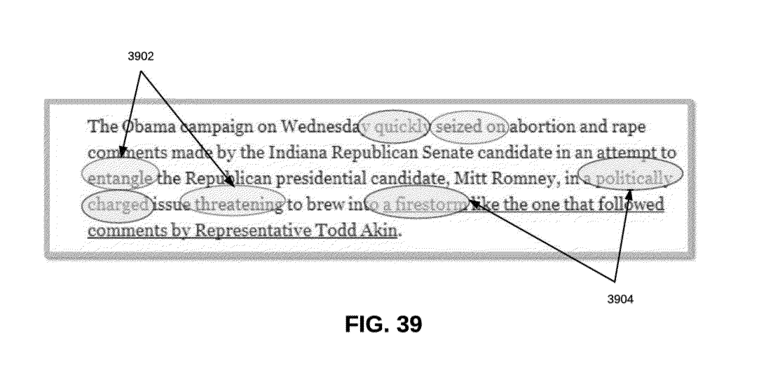

Additionally, dependency grammar parsing also surfaces the writing style and writing tone of extracted text. FIG. 39 illustrates how style 3902 and tone 3904 are extracted from text and used to help define semiotic stories. Extracted markers are used to define isotopy codes that give rise to style and tone. Here, the style 3902 of the article is aggressive and the tone 3904 is excited, pursuant to the dependency grammar parsing performed in on the extracted markers.

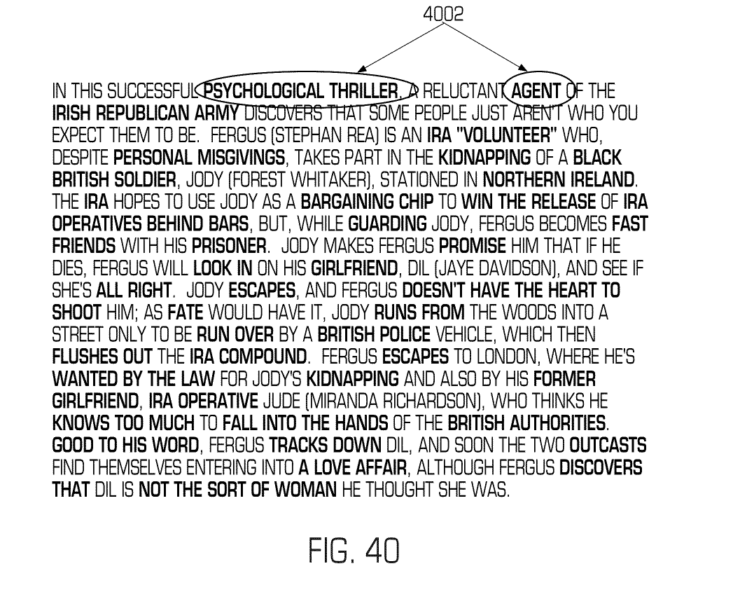

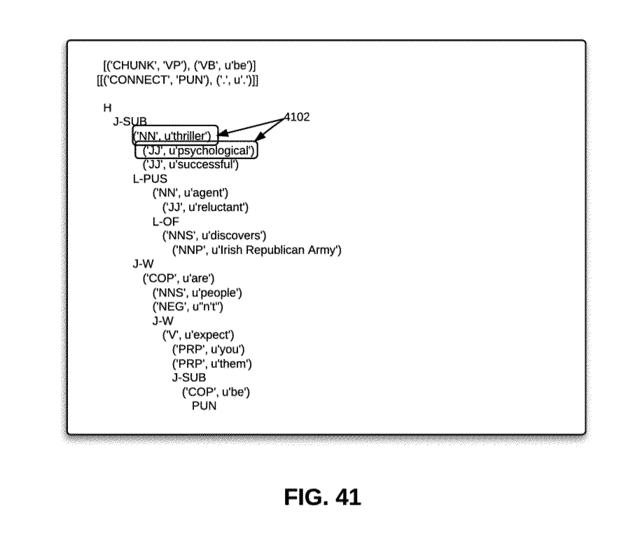

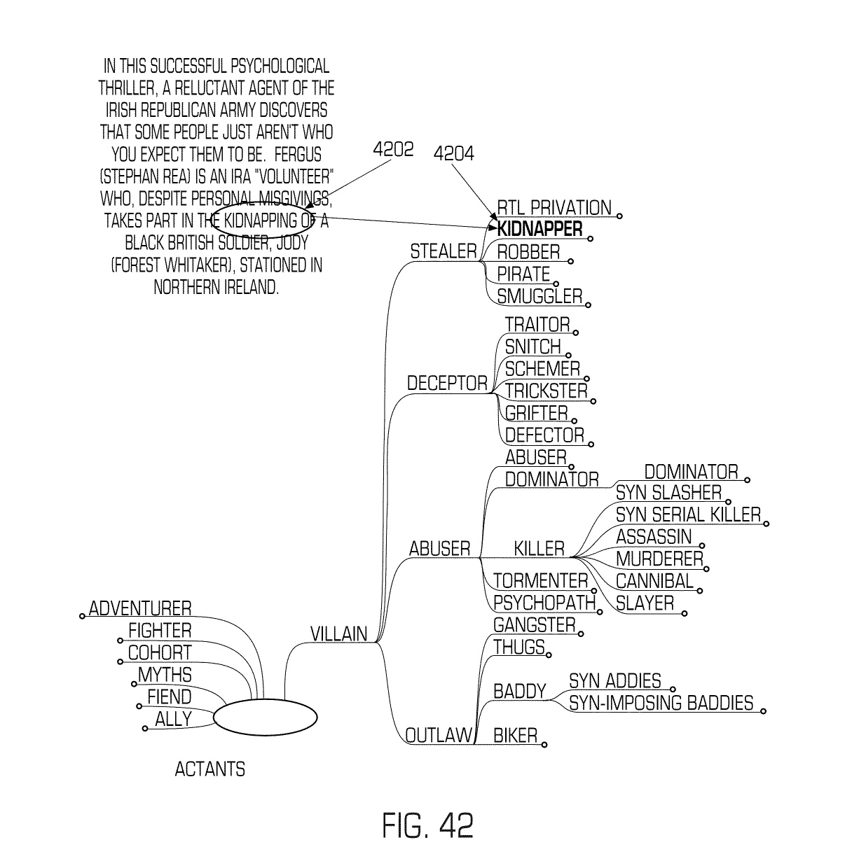

FIG. 40 illustrates another sample of an article to be collected and analyzed for semiotic stories. The article consists of a review of the movie “The Crying Game”. The words highlighted in bold are extracted markers that helps define the genre, isotopies, style and tone of the review. These elements are combined with functions and actants to form stories. This article is parsed using dependency grammar to surface narrative dependencies, illustrated in FIG. 41. Here, dependency grammar parsing starts by identifying the verbs 4102 in each sentence, then identifying entities, arguments and functions attached to the verb. These entities, arguments and functions define features of the semiotic stories to be extracted from the article FIG. 42 illustrates how words extracted from the article in through dependency grammar parsing are mapped in the ontology. For example, the word “kidnapping” 4202 serves as a topic marker, having a place 4204 in the ontology. This ontological map shows how the extracted word is related to other extracted markers in the ontology, which may be leveraged into recommendations for content items containing markers that are in close proximity in the ontology.

By extracting and parsing the bolded words through dependency grammar, many different elements comprising semiotic stories identified and surfaced. Through surfacing these elements, the system and method described in this disclosure can determine the genre, isotopies, style and tone, functions and actants in order to create semiotic stories. For example, the extracted language can help define the genre of the text, in this case, the genres for “The Crying Game” consist of psychological drama, political thriller, and terrorism. Further, the extracted text can define the style and tone of the text, which here is Tragic and Romantic Love. Even further, functions are surfaced through parsing of the extracted text (e.g., Assassination Plots, Abduction, Redemption), along with actants (e.g., Soldier, Transvestite). All of these surface elements are combined to tell the semiotic story of the text.

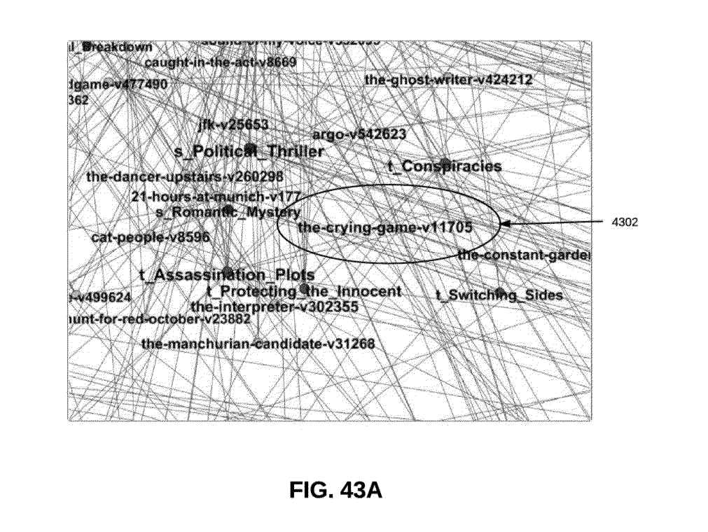

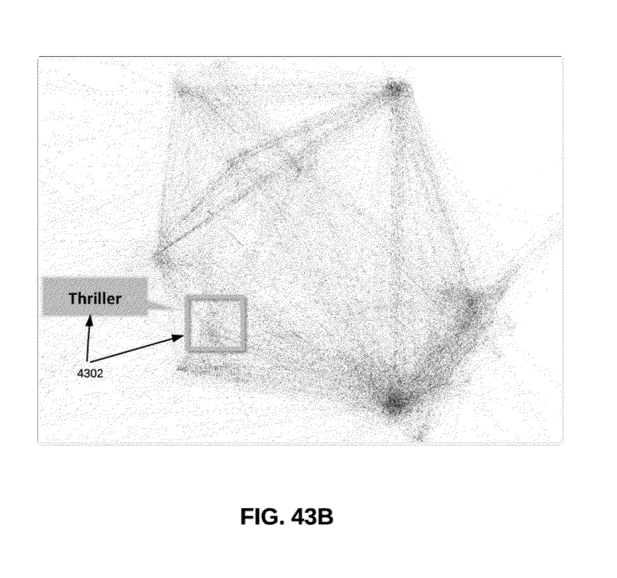

Documents can be mapped according to their extracted semiotic stories, resulting in the creating of a network of semiotic relationships between the documents. FIG. 43A illustrates how the sample document (“The Crying Game” review) is mapped with other documents regarding films in corpus. By mapping “The Crying Game” 4302 pursuant its extracted semiotic story, non-obvious relationships with other movies may be surfaced, such as the movie's proximity to other films, like “The Constant Gardener” 4304. While the setting and plots of the movies are very different, their extracted semiotic stories are similar (e.g., assignation plots 4306), surfacing a new relationship that can be leveraged for recommendation. Additionally, extracted semiotic stories may be used to group content items into categories. An expanded view of the ontological map is illustrated in FIG. 43B. Here, “The Crying Game” is clustered with movies that share extracted semiotic stories containing elements that pertain to the genre of “Thriller” 4308. If a user demonstrates a propensity for certain genre clusters, movies mapped near that cluster may also be recommended to the user.

In the preferred embodiment of the methods and systems described herein, the writing styles and genres defined in the metrics process are used to categorize collected documents and index the documents according to their respective categorizations. These categorizations would be used to push documents to the user based on a user's tracked preferences for certain writing styles. For example, if a user frequently searches for or selects documents that are didactic in nature, such as educational texts, the writing style and genre analysis system and method is able to define the semiotic markers of this classification and return documents to the user that are also indexed as didactic. Or, if a user frequently searches for or selects documents that are narrative in nature, such as novels, stories, etc., the writing style and genre system and method is able to define makers of a narrative style or genre and push other documents similarly indexed to the user.

Additionally, articles and other documents would be analyzed for their writing tone and sentiment and indexed with like documents in order to provide more personalized and specific content recommendations by leveraging user preferences for certain writing tones. Articles and documents would be pushed to a user based on the user's tracked preferences for certain writing tones. These articles and documents would be indexed and grouped with articles and documents containing a similar writing tone. Thus, when a user demonstrates a preference for documents with a certain tone profile, other documents with a similar tone profile would be recommended to the user.

Further, writing style and tone analysis may be combined with semiotic personas to recommend relevant content to users based on their preferences. Entity personas may be created for entities by parsing articles and other documents to identify istotones, which would serve as the basis for the entities' persona. Entity personas would be mapped and compared according to their isotopies to determine the semiotic distance between any two given entities. Documents would be indexed according to this semiotic distance, which would be leveraged into relevant content recommendations.

Even further, writing style analysis, writing tone analysis and semiotic personas may be combined with extracted semiotic stories and leveraged as content recommendations. Semiotic stories may be extracted from articles and other documents through dependency grammar parsing, surfacing narrative dependencies comprised of functions, actants, isotopies, writing style and writing tone. These dependencies would be mapped in various semiotic models in order to define semiotic stories. These dependencies would also be mapped in various ontologies in order to create a network of relationships that can be leveraged to recommend online content items to users.

Embodiments of the systems and methods described herein can be applied to a plurality of entertainment domains, including music, movies and TV, sports, games, etc. Additionally, embodiments of the systems and methods described herein can be applied to a plurality of news domains, including celebrity news, political news, business news, society news, technology news, etc. Further embodiments of the systems and methods disclosed herein may be applied to virtually any text, including product reviews, descriptions, abstracts, etc.

Embodiments of the systems and methods described herein have numerous applications. For example, such systems and methods may be part of a search engine feature to recommend articles, documents, and other types of content to a user based on a query. In another embodiment, the systems and methods described herein may be part of a webpage or website to help recommend content to users. In yet another embodiment, the system and method described herein may also be applied to online content other than articles or documents, such as movies, music, images, etc., to recommend content items with related semiotic stories.

While the foregoing has been with reference to a particular embodiment of the invention, it will be appreciated by those skilled in the art that changes to this embodiment may be made without departing from the principles and the spirit of the disclosure, the scope of which is defined by the appended claims.

1. A method of analyzing and mapping semiotic relationships, the method comprising:
collecting, using a computer based system, documents;
gathering, using the computer based system, one or more metrics from the documents;
analyzing, using the computer based system, the semiotic attributes of the documents based on the one or more metrics;
mapping, using the computer based system, semiotic personas for entities contained in the documents based on the semiotic attributes;
extracting, using the computer based system, semiotic stories from the documents based on the semiotic personas mapped to entities; and
recommending, using the computer based system, documents to a user based on the extracted semiotic stories.

2. The method of claim 1, wherein analyzing semiotic attributes further comprises analyzing a writing style or genre and a writing tone or sentiment of the documents.

3. The method of claim 2, further comprising defining one or more writing styles or genres based on gathered metrics.

4. The method of claim 3, further comprising gathering metrics regarding oe or more of text readability, structure, discourse and content from one or more metrics tables.

5. The method of claim 1, further comprising defining one or more isotones based on semiotic markers gathered from collected documents.

6. The method of claim 5, further comprising using dependency grammar parsing to identify semiotic markers from collected documents.

7. The method of claim 1, wherein mapping entity personas further comprises defining entity personas based on gathered semiotic features.

8. The method of claim 7, further comprising using dependency grammar parsing to identify semiotic features contained in collected documents.

9. The method of claim 1, wherein extracting semiotic stories further comprises extracting, aggregating, and mapping narrative dependencies.

10. The method of claim 9, wherein extracting narrative dependencies further comprises extracting narrative dependencies including functions, actants, and isotopies in order to define a plurality of semiotic models.

11. A system for analyzing and mapping semiotic relationships, the system comprising:
a storage device that stores an index and one or more documents;
a server; and
the server having a writing style and genre analysis engine that analyzes a writing style or genre of the one or more documents, a writing tone and sentiment analysis engine that analyzes a writing tone or sentiment of the one or more documents, a semiotic story aggregation and extraction engine that aggregates and extracts semiotic stories in the one or more documents based on the writing style or genre and writing tone or sentiment of the one or more documents, an entity semiotic persona engine that maps semiotic personas for entities contained in the one or more documents based on the semiotic stories, and a recommendation engine that recommends a document to a user based on the semiotic personas for entities contained in the one or more documents.

12. The system of claim 11, further comprising a crawler to extract text from the one or more documents.

13. The system of claim 12, further comprising a parser for parsing extracted text using dependency grammar parsing.

14. The system of claim 13, further comprising a tokenizer to stem the tokens, identify parts-of-speech, locutions and phrasal verbs in the parsed extracted text.

15. The system of claim 11, further comprising a matching engine to match documents with similar semiotic attributes based on finding correlations in gathered metrics and narrative functions.

16. A computer software product that includes a non-transitory medium readable by a processor, the medium having stored thereon a set of instructions for analyzing and mapping semiotic relationships, the instructions comprising:
a first set of instructions that cause the processor to collect one or more documents;
a second set of instructions that cause the processor to gather metrics from one or more documents;
a third set of instructions that cause the processor to the analyze the semiotic attributes of one or more documents based on the gathered metrics;
a fourth set of instructions that cause the processor to map semiotic personas for entities extracted from one or more documents based on the semiotic attributes;
a fifth set of instructions that cause the processor to extract semiotic stories from one or more documents based on the semiotic personas for the entities in the one or more documents; and
a sixth set of instructions that cause the processor to recommend one or more documents to users based on their semiotic stories.

17. The computer implemented software product of claim 16, wherein the instructions that analyze semiotic attributes further comprises instructions that analyze the writing style or genre and the writing tone or sentiment of the collected documents.

18. The computer implemented software product of claim 17, wherein the instructions that analyze the writing style or genre further comprises instructions that define one or more writing styles and genres based on gathering metrics from the collected documents.

19. The computer implemented software product of claim 18, wherein the instructions that gather metrics further comprises instructions that gather metrics regarding text readability, structure, discourse and content from one or more metrics tables.

20. The computer implemented software product of claim 16, wherein the instructions that analyze writing tone or sentiment further comprises instructions that define one or more isotones based on one or more semiotic markers gathered from collected documents.

21. The computer implemented software product of claim 20, wherein the one or more semiotic markers are surfaced through dependency grammar parsing performed on the collected documents.

22. The computer implemented software product of claim 16, wherein the instructions that map entity personas further comprises instructions that define entity personas based on gathered semiotic attributes.

23. The computer implemented software product of claim 22, wherein semiotic attributes are surfaced through dependency grammar parsing.

24. The computer implemented software product of claim 16, wherein the instructions that extract semiotic stories further comprises instructions that extract, aggregate, and map narrative dependencies.

25. The computer implemented software product of claim 24, wherein instructions that extract narrative dependencies further comprises instructions that extract functions, actants, and isotopies in order to define a plurality of semiotic models.
